(19) United States
(12) Patent Application Publication
(10) Pub. No.: US 2011/0227696 A1
(43) Pub. Date: Sep. 22, 2011

(54) OPERATION SYSTEM

(76) Inventors: Kazuhiko Miyata, Osaka (JP); Toshio Nomura, Osaka (JP); Sunay Suryakant Shah, Oxford (GB); Michael James Brownlow, Oxford (GB)

(21) Appl. No.: 13/130,597

(22) PCT Filed: Sep. 30, 2009
(86) PCT No.: PCT/JP2009/067069

§ 371 Date: May 23, 2011

(30) Foreign Application Priority Data
Dec. 5, 2008 (JP) 2008-311623

(51) Int. Cl. G05B 19/02

(52) U.S. Cl. 340/4.3

(57) ABSTRACT

The present invention relates to an operation apparatus including an operation terminal used for operating a domestic apparatus near a wall surface. An operation host section (20) includes a module of an accessing function element and electric supply function element, which module discharges an operation signal in the air, or includes a member in which such a module is disposed in an array form. Power supply in a non-contact manner and transmission of an operation signal in a wireless manner are carried out between the operation terminal and the operation host section. The operation terminal is easily adhered extremely thin onto the wall and allows providing an operation function without providing any physical wiring. Further, few electricity is wasted, and operation is possible under conserved energy. Hence, an operation system is provided which uses an operation terminal having low security risks while achieving flexibility in its layout.

### TECHNICAL FIELD

The present invention relates to an operation system including an operation terminal mainly used near a wall surface, for example for operating a domestic apparatus.

### BACKGROUND ART

Proposals for a system have been conventionally made for centrally operating various apparatuses provided in, for example, a residence.

For instance, Patent Literature 1 discloses a general operation system including a home server which controls apparatuses provided in a residence, and the apparatuses are operated by use of an operation terminal that is connected to the home server.

Moreover, Patent Literature 2 discloses an information-intensive house in which an information-intensive apparatus is disposed on a wall of a half landing of a U-shaped staircase and an inspection hole is opened on a container containing the information-intensive apparatus, to allow easy maintenance inspection of the information-intensive apparatus provided in the house.

### CITATION LIST

### Patent Literature

### Patent Literature 1

Japanese Patent Application Publication, Tokukai, No. 2001-148889 A (Publication Date: May 29, 2001)

### Patent Literature 2

Japanese Patent Application Publication, Tokukai, No. 2002-4601 A (Publication Date: Jan. 9, 2002)

### Patent Literature 3

Japanese Patent Application Publication, Tokuhyo, No. 2005-525705 A (Publication Date: Aug. 25, 2005)

### Patent Literature 4

Japanese Patent Application Publication, Tokukai, No. 2003-244784 A (Publication Date: Aug. 29, 2003)

### SUMMARY OF INVENTION

### Technical Problem

However, the conventional general operation system provided in the residence has a problem that the operation system is not easy to use, for example when a room is made over or the like.

(Fixed Operation Terminal)

More specifically, for instance with the general operation system disclosed in Patent Literature 1, the operation terminal may be considered as connected to the home server chiefly by wired connection (wires). Further, the wires used for the connection in many cases are provided inside a wall of the residence. Moreover, a mode may also be taken in which the wires are disposed by selecting any path in an electric wire path in which the wires are indirectly provided. However, in either case, an opening on a wall from where the wire is drawn out is fixed.

Hence, the operation terminal is to be fixed on the wall of the residence.

The operation terminal fixed on the wall becomes an obstacle in a case where furniture or an ornament needs to be disposed at a position where the operation terminal is disposed, for example in a case where a room is to be made over.

Moreover, this problem also occurs in a case where the operation terminal is not connected to a plurality of apparatuses via the home server. Namely, taking a switch of a lighting as an example of the operation terminal, usually the switch is provided at a fixed position of an opening formed in advance at a position where the power source wire is pulled out from the wall.

This fixed switch may serve as an obstacle in a case where a frame to be hung on the wall is desirably changed in position.

(Remote Controller)

An operation terminal that overcomes the problems of the fixed operation terminal is what is called a remote controller. Particularly, in this example, the remote controller denotes one of a wireless type which uses light or radio waves as a transmission medium for transmitting operations.

More specifically, for instance, a lighting operable by a remote controller has been proposed. This remote controller is movable, so the problem related to the making over of the room is difficult to occur.

However, the remote controller is inconvenient in the following points: it is necessary to secure a set position for the remote controller; the remote controller is easily lost; a position of where the remote controller was placed may be forgotten; and the like.

Moreover, the remote controller may be made as a semi-fixed operation terminal, by tentatively fixing the movable remote controller to a wall or the like.

It certainly can be said that the semi-fixed operation terminal of a lighting switch or the like which is provided in a semi-fixed manner is a user-friendly operation interface.

However, the volume of the remote controller is generally large. Moreover, providing the remote controller itself so as to hang on the wall may spoil a fine appearance of the room, which appearance is an important value of the room. Furthermore, clothing or the like may get caught on a projection provided for hanging the remote controller on the wall, by which may serve as a cause of injury or damage to the clothing. That is to say, safety concerns arise by providing the remote controller or the like on the wall itself, which remote controller has a certain width and thickness.

Moreover, other problems also arise as issues, such as, often apparent with an infrared ray type remote controller, a single remote controller being able to operate other apparatuses of identical types that are provided in another room, and also a problem of being difficult to prevent mistaken operations, malfunction caused by receiving intentional disturbance from an external person, and mischief. Further, due to such an interference problem, the number of remote controllers that can operate simultaneously in a neighboring space is extremely limited, even if a terminal ID is provided.

(Example of Other Devices)

Another example of a functional product to be operated other than the lighting is an interphone.

However, the interphone is often fixed, usually in the living room or the hallway of the residence. Hence, even if the interphone is used for example as an operation terminal connected to the home server, the interphone cannot be used for checking a visitor that has arrived while a resident is occupied in the bathroom.

On this account, an interphone of a type that is connectable to a cordless phone has also been considered. With this type of interphone that can be connected to the home server without using a code, correspondence is limited to communication between a parent machine and a child machine, each of which include a function that can cooperate with the facilities. Hence, the multiplicity of use in free connection between a plurality of different products is low. Therefore, problems arise that the facilities become complex and redundant, and that interconnection is not possible between different makers.

In a case of not an extension function of a cordless phone but a remote controller used via a public network, full utilization of a general-purpose browser function disclosed in Patent Literature 1 allows operation from a mobile phone or the like that has a same type of function, even if the maker is different. However, the remote controller essentially is made to be in connection with the public network. This incurs connection costs, and further causes a fear that the operation may become not possible depending on which room due to the connection being out of a range of the public network service in that room.

Furthermore, in a case where a terminal such as the cordless phone, which transmits signals in wireless contact and in relatively long distances, is used as a switch of the lighting or an interphone terminal, security problems as described below may occur, as with the remote controller.

(Security Risks)

Namely, the conventional wireless operation terminal is originally in the risk of being observed, eavesdropped, illegally operated externally, and the like.

Particularly, these security risks become more of an issue in a case where a wireless access interface of a low-power system such as a cordless phone or interphone is used.

For example, in a case where a cordless phone is used as the operation terminal, the security risks become more of an issue since the cordless phone has a relatively broad (several ten meters radius) service area range. A radio wave type remote controller has a security problem applying correspondingly to this.

(Environmentally-Friendly House)

Moreover, in view of what is called energy conservation, proposals have been made to cover the lighting not by just providing one lighting on the ceiling for each room but by providing a plurality of lights and by illuminating positions where necessary in spots. Namely, proposals have been made to have the plurality of lightings disposed in the room work together in accordance with a use of the room, to limit the consumption of electricity to just a required range, so that the amount of electricity consumption is reduced. Particularly, lightings using light emitting diode (LED) have been proposed in recent years; LED allows remarkably reducing a size of the light emitting section as compared to the conventional fluorescent lamps and heating wires, or of a discharge-type light emitting device. This provides the possibility of applying an energy conservation use by disposing a large number of small-sized lighting devices and appropriately controlling these lighting devices. LED simultaneously reduces the trouble to replace the lighting due to its long duration and further is low in heat generation by its high efficiency. Hence, expectations of these uses are high with the LED.

As a result, with an environmentally-friendly house which has a plurality of these small-sized lightings provided, there is the possibility that the electricity consumption may be remarkably reduced by locally optimizing the illuminated places.

However, corresponding to the plurality of numbers of lightings, the switches increase in number, and this may cause the switches to be provided all over the house.

Furthermore, such a situation causes the operation of the lighting to be felt as a bother. Therefore, a solution that makes it easy to collectively provide a plurality of operation systems in an arbitrary position has been longed for.

The present invention is accomplished in view of the problems, and its object is to provide an operation system using an operation terminal which achieves flexibility in layout while having low security risks.

Moreover, a further object of the present invention is to provide an operation terminal that is extremely thin and is easily adhered to the wall, is capable of providing operation functions without physically being wired, and further wastes few electricity and which operates under conserved energy.

### Solution to Problem

In order to attain the object, an operation system of the present invention includes: an operated apparatus; an operation host section connected to the operated apparatus; and an operation terminal configured to operate the operated apparatus via the operation host section, being supplied with power from the operation host section in a non-contact manner, the operated apparatus being operated by use of an operation signal, the operation signal being transmitted between the operation terminal and the operation host section in a non-contact manner, and the operation terminal and the operation host section being disposed so that the supplying of the power and the transmission of the operation signal are carried out within a range in which a distance between the operation apparatus and the operation host section is not more than 5 cm.

Moreover, the operation system of the present invention is configured in such a manner that the operation apparatus and the operation host section are disposed so that the supplying of the power and the transmission of the operation signal are carried out within a range in which the distance between the operation terminal and the operation host section is not more than 2 cm.

According to the configuration, supplying of power in a non-contact manner and wireless transmission of an operation signal are carried out between the operation terminal and the operation host section. Hence, it is possible to achieve flexibility in a layout for disposing the operation terminal.

Moreover, according to the configuration, the supplying of the power and the transmission of the operation signal are carried out within a range of a set distance between the operation terminal and the operation host section. Hence, interception or the like of the operation signal is held down, thereby reducing security risks.

Moreover, the operation system of the present invention is configured in such a manner that at a time when the power is supplied from the operation host section to the operation terminal, the supplying is carried out under an energy transfer rate of at least 10%.

Moreover, the operation system of the present invention is configured in such a manner that the energy transfer rate is not less than 60%.

According to the configuration, it is possible to supply the power from the operation host section to the operation terminal with good efficiency. As a result, wasted electricity is reduced in amount.

Moreover, the operation system of the present invention is configured in such a manner that the operated apparatus is a domestic apparatus, and the operation host section is shaped as a substrate and is disposed on a wall of a room inside a house.

Moreover, the operation system of the present invention is configured in such a manner that the operation host section shaped as a substrate is disposed on a surface of the wall of the room inside the house.

Moreover, the operation system of the present invention is configured in such a manner that the operation host section shaped as a substrate is disposed inside the wall of the room inside the house.

Moreover, the operation system of the present invention is configured in such a manner that the operated apparatus is a domestic apparatus, and the operation host section is shaped as a substrate and is disposed on a floor of a room in a house.

Moreover, the operation system of the present invention is configured in such a manner that the operated apparatus is an domestic apparatus, and the operation host section shaped as a substrate is disposed on a surface of the floor of the room of the house.

Moreover, the operation system of the present invention is configured in such a manner that the operated apparatus is an domestic apparatus, and the operation host section shaped as a substrate is disposed inside the floor of the room of the house.

According to the configuration, the operation host section is provided on the wall or floor of a room inside a house, so there is no need to prepare a separate base material or the like for providing the operation host section.

Moreover, with the configuration in which the operation host section is provided on the surface of the wall or floor, it is easy to posteriorly provide the operation host section, for example when remodeling the house.

Moreover, with the configuration in which the operation host section is provided inside the wall or floor, the operation host section cannot be seen from the outside, so it is possible to prevent the decrease in decorativeness caused by providing the operation host section.

Moreover, the operation system of the present invention is configured in such a manner that the operation host section shaped as a substrate is disposed inside a depression formed on the wall of the room inside the house.

Moreover, the operation system of the present invention is configured in such a manner that the wall is made of material that allows easy forming of the depression in which the operation host section is disposed.

According to the configuration, the operation host section is provided in a depression on the wall. This prevents the wall from having a projection (projected part), caused by providing the operation host section.

Moreover, in a case where the wall is configured so that a depression can be easily formed, it becomes easy to what is called posteriorly provide the operation host section in a depression on the wall, for example when remodeling the house.

Moreover, the operation system of the present invention is configured in such a manner that the operation host section shaped as a substrate is disposed on substantially a whole surface of the wall of the room.

According to the configuration, the operation host section is provided on an entire surface of the wall. Hence, a user of the operation system can operate the operation terminal without minding a position of the operation host section.

Moreover, the operation system of the present invention is configured in such a manner that the operation host section shaped as a substrate is disposed on the wall of the room just near a position of the room at which a user of the room operates the operated apparatus in accordance with a main use of the room.

Moreover, the operation system of the present invention is configured in such a manner that, on a wall of a staircase inside the house, the operation host section shaped as a substrate is disposed so that the operation host section runs along an inclination of the staircase.

According to the configuration, the operation host section is provided just at a required position on the wall. Hence, it is possible to hold down costs required for providing the operation host section.

Moreover, the operation system of the present invention is configured in such a manner that a plurality of pieces of the operation host section shaped as a substrate are disposed on a single surface of the wall.

Moreover, the operation system of the present invention is configured in such a manner that the plurality of pieces of the operation host section shaped as a substrate are rectangular-shaped, and are disposed on the single surface of the wall so that the plurality of pieces of the operation host section are disposed parallel to each other.

Moreover, the operation system of the present invention is configured in such a manner that the plurality of pieces of the operation host section shaped as a substrate are substantially square-shaped, and are disposed on the single surface of the wall so that the plurality of pieces of the operation host section form a matrix.

Moreover, the operation system of the present invention is configured in such a manner that the operated apparatus is a domestic apparatus, and a plurality of pieces of the operation host section shaped as a substrate are disposed on a single surface of the floor.

Moreover, the operation system of the present invention is configured in such a manner that the plurality of pieces of the operation host section shaped as a substrate are substantially square-shaped, and are disposed on the single surface of the floor so that the plurality of pieces of the operation host section form a matrix.

According to the configuration, a plurality of pieces of the operation host section is provided on the wall or floor. Accordingly, just an operation host section for example that is close to the operation terminal can be selectively driven. Hence, active driving of the operation host section is possible.

Moreover, in a configuration in which rectangular operation host sections are disposed parallel to each other, it is possible to easily achieve the active driving.

Moreover, with a configuration in which the operation host sections are disposed so as to form a matrix, it is possible to achieve highly accurate active driving.

Moreover, the operation system of the present invention is configured in such a manner that the operation terminal has no independent power source.

According to the configuration, it is possible to simplify the operation terminal, and achieve a thin and lightweight operation terminal.

Moreover, the operation system of the present invention is configured in such a manner that the operation terminal includes a simplified power storage capable of continuously operating for a short term outside a power supplied range.

According to the configuration, the operation terminal includes a simplified power storage. This allows stable operation at a time of a sudden obstacle such as a momentary or short-term power failure, without causing any confusion in the operation system or without losing the thin and lightweight properties of the operation terminal.

Moreover, the operation system of the present invention is configured in such a manner that the operation terminal includes a fixing device configured to fix the operation terminal near the operation host section.

Moreover, the operation system of the present invention is configured in such a manner that the fixing device is provided so that repetitive fixing and detaching is possible.

Moreover, the operation system of the present invention is configured in such a manner that the fixing device is adhesive material.

According to the configuration, the operation terminal is easily fixed near the operation host section, more specifically, for example on a wall surface or floor surface.

Moreover, in a case where the fixing device is capable of being fixed and detached repeatedly, namely, in a case where the fixing device has a repeating function, the operation terminal can be easily changed in position to a position easily used by the user.

Moreover, in a case where the fixing device is adhesive material, it is possible to easily achieve a fixing device that is capable of fixing, detaching, and refixing.

Moreover, the operation system of the present invention is configured in such a manner that the operation terminal includes means which allows confirmation of an operation target by sight or touch.

Moreover, the operation system of the present invention is configured in such a manner that the means includes an excitation source configured to vibrate together with the operation of the operation terminal, so that the operation object can be confirmed by touch.

Moreover, the operation system of the present invention is configured in such a manner that the operation terminal includes an electrically operating display section.

Moreover, the operation system of the present invention is configured in such a manner that the display section is a dot matrix type display section.

According to the configuration, the user of the operation terminal can operate the operation terminal easily and accurately in conformity with details confirmed by sight or touch.

Moreover, in a case where an excitation source is provided in the operation terminal, the user of the operation terminal can confirm the operation target more easily by touch.

Moreover, in a case where an electrically operating display section is provided in the operation terminal, details (displayed details) displayed on the display section can be easily changed. By changing the displayed details, it is made easy to add various functions to the operation terminal.

Moreover, particularly in a case where the display section is a dot matrix type display section, it is possible to improve freedom of displayable images, and allows easier attainment of high quality display.

Moreover, particularly in a case where the display section is a liquid crystal display section, it is possible to manufacture the display section together with other function elements. Hence, the operation terminal is more easily manufactured.

Moreover, the operation system of the present invention is configured in such a manner that the operation signal transmitted between the operation terminal and the operation host section is transmitted via electromagnetic waves.

According to the configuration, an operation signal is transmitted via electromagnetic waves. This makes it easy to share elements for transmitting the operation signal and elements for supplying the power, thereby allowing simplification of the configuration of the operation system.

Moreover, the operation system of the present invention is configured in such a manner that the operation signal transmitted between the operation terminal and the operation host section is transmitted via light.

According to the configuration, the operation signal is transmitted via light. This further reduces the security risks.

Moreover, the operation system of the present invention is configured in such a manner that the light is visible light and the operation system is designed so that the light is usable as decoration.

According to the configuration, the light is to have intensity that is visible by the eye, and the light can be actively used as a part of decorations on the wall. This improves its appearance.

The operation terminal includes a load impedance modulation section configured to change a load, the operation host section includes a load modulation detection section configured to detect a change in electric current that flows in a constant-voltage power source, the change being caused by a change in the load, and the operation signal is transmitted from the operation terminal to the operation host section upon detecting the change in electric current.

According to the configuration, signal transmission between the flotage and the peer is carried out by simple means.

Moreover, the operation system of the present invention is configured in such a manner that the operated apparatus is a domestic apparatus, a plurality of the domestic apparatus are provided inside a house, and the operation host section is connected to a home server connected to the plurality of the domestic apparatuses.

According to the configuration, a plurality of apparatuses inside a house can be operated by the operation terminal via the home server.

Moreover, the operation system of the present invention is configured in such a manner that the operated apparatus is a car device mounted on a car, the operation host section shaped as a substrate, and the operation host section shaped as a substrate is disposed on an interior decoration of the car.

According to the configuration, operation of a car apparatus in the car is easily carried out from a position which allows easy operation by a driver or a fellow passenger.

### Advantageous Effects of Invention

As described above, in an operation system of the present invention, an operation terminal operates an operated apparatus via an operation host section or an operation host section shaped as a substrate. The operation terminal is supplied with power from the operation host section in a non-contact manner, and an operation signal for operating the operated apparatus is transmitted between the operation terminal and the operation host section in a wireless manner or by use of light or the like. Further, the operation terminal and the operation host section are disposed so that the supplying of the power and the transmission of the operation signal are carried out within a range in which a distance between the operation apparatus and the operation host section is not more than 5 cm.

Hence, an effect is attained that an operation system is provided which uses an operation terminal having low security risks while achieving flexibility in its layout.

### BRIEF DESCRIPTION OF DRAWINGS

FIG. 1 illustrates an embodiment of the present invention, and is a view schematically illustrating a configuration of an operation system.

FIG. 2 is a view related to a nc-Si light emitting phenomenon; (a) illustrates a configuration example of a light emitter, and (b) illustrates an integrated example including peripheral circuitry.

FIG. 3 illustrates an embodiment of the present invention, and is a view schematically illustrating a configuration of an operation system.

FIG. 4 is a view illustrating an embodiment of the present invention; (a) illustrates a state of a flotage at a time when operation of the flotage is off, and (b) is a state of the flotage at a time when the operation of the flotage is on.

FIG. 5 illustrates an embodiment of the present invention, and is a view illustrating an example of a VSR transceiver.

FIG. 6 illustrates an embodiment of the present invention, and is a view illustrating how a peer is disposed on a wall, from a plan view perspective.

FIG. 7 illustrates an embodiment of the present invention, and is a view illustrating how a peer is disposed on a wall, from a cross-sectional view perspective.

FIG. 8 illustrates an embodiment of the present invention, and is a view illustrating how a peer is disposed on a wall, from a plan view perspective.

FIG. 9 illustrates an embodiment of the present invention, and is a view illustrating how a peer is disposed on a wall, from a plan view perspective.

FIG. 10 illustrates an embodiment of the present invention, and is a schematic view illustrating a configuration of a peer.

FIG. 11 illustrates an embodiment of the present invention, and is a view illustrating a load impedance of a flotage and a power source current value of a peer.

FIG. 12 illustrates an embodiment of the present invention, and is a view schematically illustrating an element related to electric supply.

FIG. 13 is a view illustrating an embodiment of the present invention; (a) illustrates a waveform of a continuous electric supply, and (b) illustrates a waveform of an intermittent electric supply.

FIG. 14 is a view illustrating an embodiment of the present invention, and illustrates a configuration of a peer in capacitive coupling.

FIG. 15 is a view illustrating an embodiment of the present invention, and schematically illustrates a configuration of a light transmission and reception surface.

FIG. 16 is a view illustrating an embodiment of the present invention; (a) schematically illustrates a configuration of an operation system (of an image display system), and (b) schematically illustrates a configuration of an operation system (of an operation transmission system).

FIG. 17 is a view illustrating an embodiment of the present invention, and schematically illustrates a configuration of a flotage (just of an image display system).

FIG. 18 is a view illustrating an embodiment of the present invention, and schematically illustrates a configuration of a flotage.

FIG. 19 is a view illustrating an embodiment of the present invention, and illustrates how an operation system is used in a western-style room.

FIG. 20 is a view illustrating another embodiment of the present invention, and illustrates how an operation system is used inside a car.

FIG. 21 is a view illustrating another embodiment of the present invention, and illustrates how an operation system is used as a frame in a wall.

FIG. 22 is a view illustrating another embodiment of the present invention, and illustrates how an operation system is used in a game.

### DESCRIPTION OF EMBODIMENTS

Before going into specific descriptions of embodiments with reference to drawings, first described is a summary of the embodiments of the present invention. The embodiments will be specifically described later, for each of the embodiments.

(Wall Having Accessing Function (Peer))

An operation system of the present invention is usable as a system for operating various apparatuses inside a residence for example, such as lighting, electrical appliances and the like.

An example of the operation system may be one in which a wall of a residence is given an accessing function (accessed function), and an operation terminal that is accessible to the wall given the accessing function accesses the wall.

More specifically, the wall having the accessing function is for example provided by disposing an access system made up of a sheet member inside the wall simultaneously with disposing a surface material on the wall or disposing inner material such as heat insulating material in the wall. In the embodiment, the access system denotes a system in which various apparatuses are connected to a home server, whereby allowing centralized operation.

Use of the wall as accessing means is advantageous in that since the accessing means can be provided as wall paper or wall material, it is possible to provide the accessing means which is also capable of mounting operation means at any location suitable for operation, by having the accessing means be incorporated into the “wall”, without spoiling a fine appearance of the room.

Examples of members constructing the accessing means encompass: a member in which minute inductors are disposed in a gridlike fashion; and a member which is mounted in such a manner that leaked radio waves from an unshielded flat conductor having a large surface area can be utilized.

Moreover, a member constructing the accessing means may be one in which an inductor grid supplying just power to an operation terminal that serves as a terminal device later described is included, and in which light emitting devices and light receiving devices which exchange signals are provided for example as an array with set intervals.

Furthermore, the members constructing the accessing means may provide not the inductors but electrode plates in a gridlike fashion, which electrode plates are paired with a flotage later described to constitute condensers.

An accessing device disposed on the wall supplies power (electricity) and signals to a range within several centimeters from the surface of the wall, in a non-contact manner. In a case where an optical device is used for transmitting and receiving signals, this distance allows sufficient communication of signal transfer by use of a weak signal that cannot be visually seen (optical power in a range around 0.01 W/m² to 0.1 W/m²). It is also possible to use infrared light which is always invisible, having a wavelength from around 800 nm to around 1000 nm.

The communication function (accessing device) is not necessarily provided to an entire surface of the wall. For instance, various apparatuses such as a switch is generally limited in its height and the like that is useful, in accordance with its use. Hence, it is possible to limit application of the function to just within the width corresponding to the useful range. This reduces the costs, and further improves the security.

A wall including such an electric supply/signal transmitting and receiving function is interactively connected to wiring such as signal lines and the like that are connected to the home server, in a region inside a building which is higher than the ceiling such as an attic, or at a portion of a pillar that does not serve as a decoration.

Moreover, in a case where the connection utilizes leaked radio waves, a coupler or the like is required, which for example sends out waves generating suitable leakage radio waves from a sheet edge. However, in a case where a transmitting and receiving element group designed in array in advance is used, connection to a trunk access line of the (home) server is possible by use of a simple connecting method, such as: simply using a contact terminal or connector at an end part of a draw-out line; soldering; clipping; crimping; conductive pasting; or the like.

The wall having this accessing function can be decorated as with a conventional wall, whereby maintaining a fine appearance creation function of the room. Moreover, in order to deliberately and clearly show a provided part while not spoiling the fine appearance, a decoration may be made which indicates a part where the accessing function is provided. As a result, it is possible to visually notify at where the accessing function is activated, thereby remarkably improving the convenience for the user.

Note that in terms of security and compatibility with remodeling, it is preferable that the trunk accessing line be wired and be a line shortest as possible which can be fixed in position.

(Information Raft (Flotage))

Next described is an operation terminal (control terminal, flotage) which accesses the accessing system.

This operation terminal is provided as a “flotage” that can, for example, drift about the wall, in other words, can be relocated anywhere on the wall. A specific example of a mounting method (formation method) of the flotage is a method in which an inductor, a condenser, a transistor, a diode, a light emitting element, a light receiving element, wiring, other constituents of an integrated circuit, a display section (pixel) and like members are collectively formed on a substrate by use of photolithographic means, which substrate is made of transparent material such as glass or plastic and is of a size ranging from around a card size to a textbook size.

For example, the flotage formed on a glass substrate has a power receiving function that receives electric supply from an electric supply device on the wall at a position close to the device, and is a device that operates without a power source as a terminal.

The flotage may include a small scale charged battery of a sheet form or a large scale condenser, for operating during a power failure or the like. However, the flotage is basically made of a thin configuration, and its framework mechanism can be configured so as to have a thickness of 2 mm to 3 mm. The flotage operates while electricity is supplied or when the flotage detects that the flotage is close to an electric supply apparatus; no unnecessary radiation is carried out in other states.

Moreover, a base material made of glass (glass substrate) further includes a circuit which: receives electromagnetic wave signals or light emitting signals; sends out signals generated or processed in the flotage as electromagnetic wave signals or light emitting signals; and modulates and demodulates these signals to process a conveyed signal.

More specifically, for instance in a case where the flotage is used as a switch, a display function of a segment or a matrix configuration, a fingertip detection function by use of light or capacitance, which fingertip detection function can detect block touching, and a terminal ID function, are provided on the glass substrate. Thereafter, a display image received from the home server, which is suitable for an operated apparatus (e.g., lighting apparatus) linked in advance or actively linked, is displayed at all times or during use, and a signal operated by a person touching is transmitted back to the (home) server via the accessing means. The flotage itself does not require knowing that the flotage serves as a “switch”, and may include an advanced information processing function or intelligence that can determine functions or operations. In the former case, the flotage simply displays the display signal transmitted from the server, and thereafter transmits back just the detected position of the finger. On the other hand, in a case where the flotage is configured so as to be intelligent, the flotage may locally store an image suitable for the switch and display that image, or may transmit back an on/off command and not the position information of the fingertip detection, in the detection. This is dependent on protocols of combined servers, and is accomplished by mounting a circuit that can adopt flexibly with that combination.

On the other hand, with a most simple flotage, the image denoting the operated apparatus does not necessarily need to be one displayed electrically, and may be means which attach a paper card on its surface. In the case of a lighting, a sticker of a picture of a switch is one example. By including a guide or the like for inserting a card on its surface, exchanging the paper card becomes easy. The flotage may also have a mechanism in which a code such as a barcode indicating a function is recorded on a back side of a card, to selectively use a processing function of the flotage by detecting the code.

Moreover, in a case where the flotage is used as an interphone, the flotage may be configured to operate so that a video of a front door camera which is relayed by the home server is displayed, or that the flotage directly communicates with the front door camera in accordance with instructions from the home server. Note that the audio input and output are already achievable by the techniques disclosed in Patent Literature 4 and like disclosures.

As described above, by using the system of the peer and the flotage, it is possible to cheaply provide a thin and lightweight general-purpose operation device (operation terminal, flotage) that is most suitable for the primary operation system, not by the conventional cooperation with the home telephone but by forming a thin film integrated circuit on a substrate such as a glass plate.

The general-purpose operation device serving as the operation terminal may include a fastening device such as an adhesive section or a suction cup, on its rear surface. This fastening device allows adhering the general-purpose operation device to the wall in a semi-fixed manner, and further allows easy movement of the general-purpose operation device.

As described above, an operation terminal is provided as an operation system, a switch, or a video terminal, which operation terminal is provided thin on any wall without spoiling the fine appearance and which allows a settled, free room layout.

Further, in a case where the operation terminal does not function as a switch, fine appearance of the room can be created by mimicking a pattern of the wallpaper, to display a same pattern as the wallpaper on the display section part.

Moreover, it is possible to provide a plurality of operation functions of lighting devices by switching the operation functions or by providing the plurality of operation functions simultaneously. These functions may be applied actively by the (home) server operation system, a linking method of the terminal ID with the operated apparatus, and like method.

Note that how to use the operation terminal is not limited to the foregoing examples.

The display section included in the operation terminal works sufficiently with a segment display in a case where a role is limited in advance as described above, whereas in a case of attaining a versatile display section, it is preferable that the display section includes a pixel matrix (dot matrix).

The display section may be any type of display section as long as the display section is an electrically operated display section, more specifically, for instance a liquid crystal display device (liquid crystal display section), an organic or inorganic EL, an electrophoresis cell, or any other mode of a planar display section that can be mounted by bulk and with low cost on a substrate panel.

Moreover, in a case where the liquid crystal display section is used, its configuration is not limited; for example, a transmissive, reflective, transflective, or a memorable liquid crystal display section may be used.

Moreover, the operation terminal may provide means for allowing confirmation of a function of operating the operated apparatus by the sense of touch, either instead of the confirmation by the sense of sight or together with the confirmation by the sense of sight. A specific example of the means is one in which a minute unevenness shaped like a switch is provided. It is also possible to provide a configuration which actively applies a stimulus such as vibration or the like to a person operating the terminal.

It has already been made clear by the inventors in an academic conference presentation, that in a case where the display of the display section is carried out by transmitted light, it is possible to receive power source for a backlight by use of a circuit on a glass substrate, of a card size or like size (AM-FPD 08, THE JAPAN SOCIETY OF APPLIED PHYSICS, 8-3 P309-312, etc.). Moreover, the presentation discloses a technique in which power and signals are transmittable within a limited distance (e.g., 1 cm), by induction coupling.

These days, IT housing is advocated, and a home server is becoming used for consolidating the functions for operating a part of the home electric appliances. Consolidating the functions is chiefly carried out with AV apparatuses and internet accessing environments, however in view of environmental friendliness, LED lighting are also becoming included. As described above, the lighting by use of LED can be easily increased in its number to be operated.

Using the flotage as the operation terminal makes it easy to achieve an IT house using LED lighting, while preventing a decrease in convenience.

The following description deals with specific embodiments, with reference to drawings.

### Embodiment 1

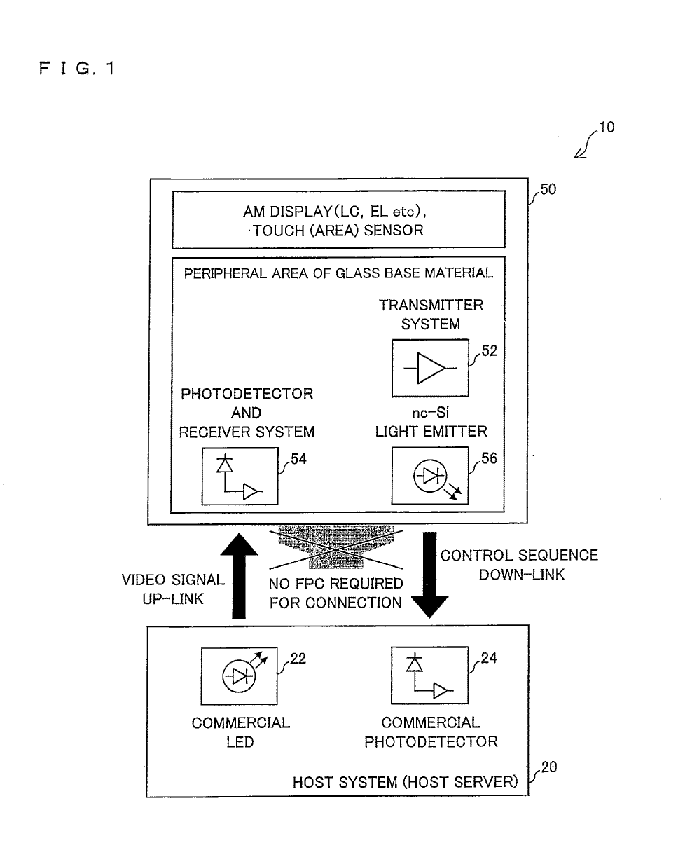

One embodiment of the present invention is described as below with reference to FIGS. 1 to 5.

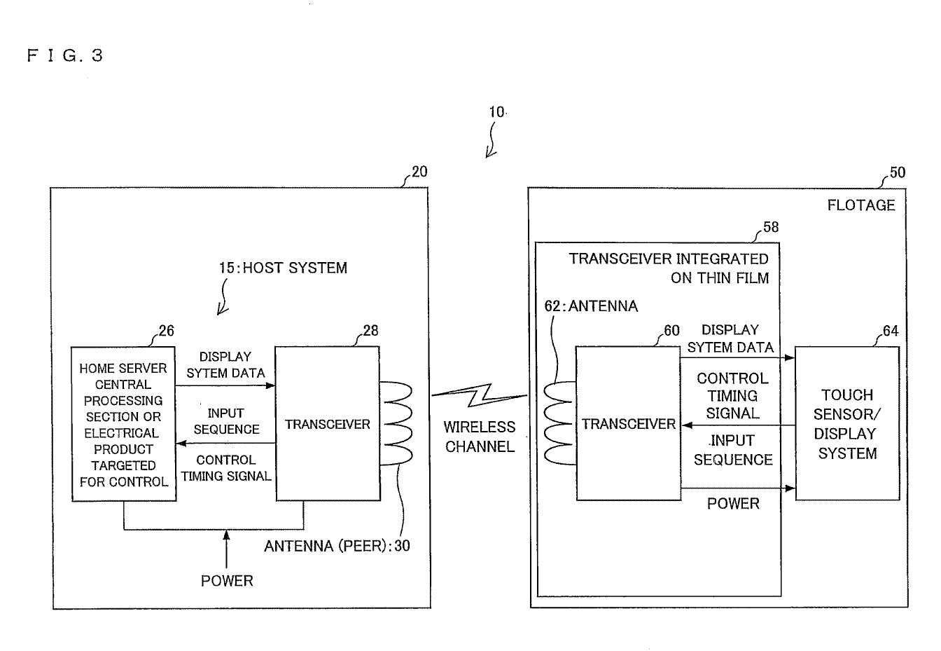

In the embodiment, FIGS. 1 and 3 are views each schematically illustrating a configuration of an entire operation system 10 of the present embodiment.

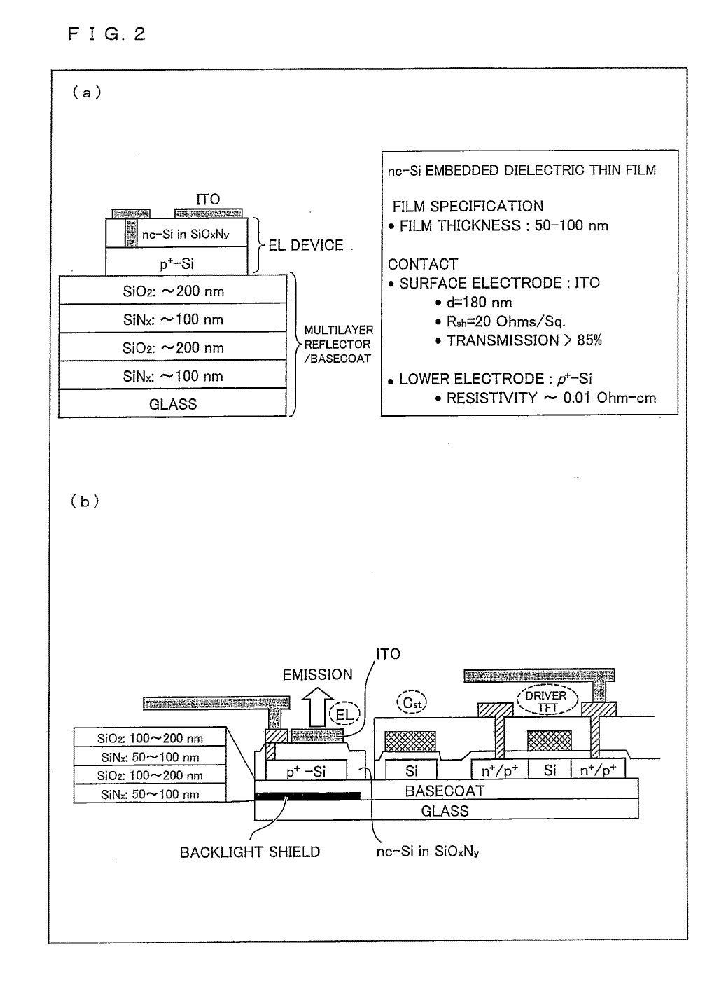

Moreover, (a) and (b) of FIG. 2 is a view related to a nc-Si light emitting phenomenon; (a) of FIG. 2 illustrates a configuration example of a light emitter, and (b) of FIG. 2 illustrates an integrated example including peripheral circuitry.

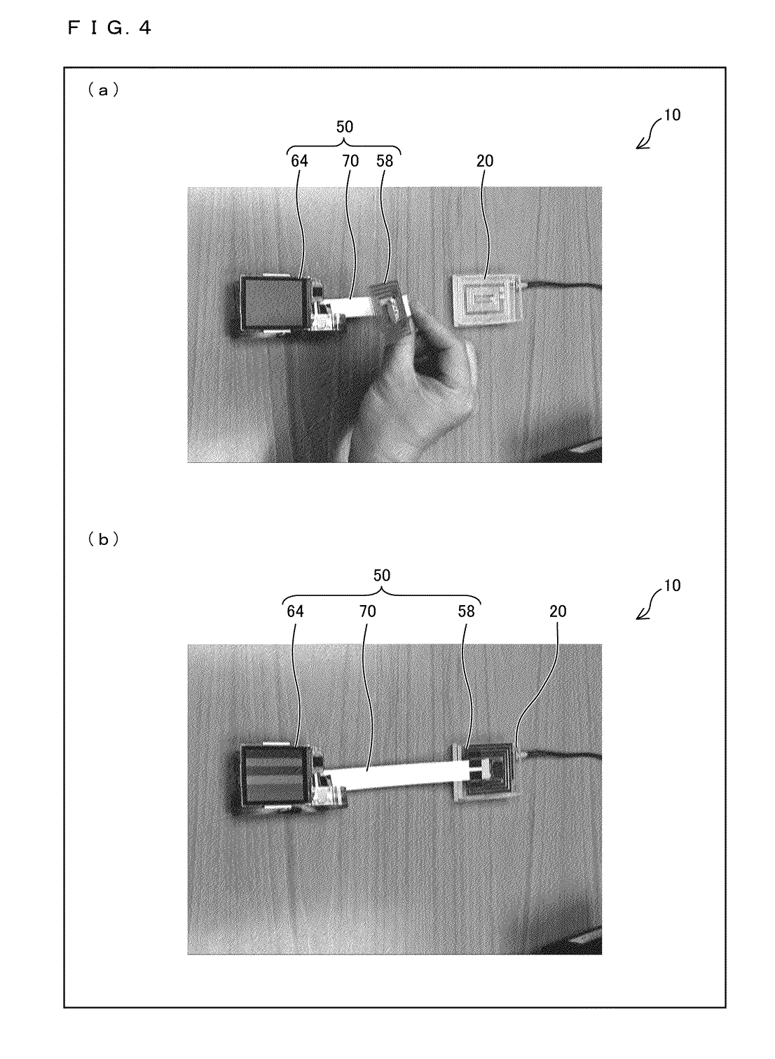

Moreover, (a) and (b) of FIG. 4 are views schematically illustrating operations of an operation system of the present embodiment; (a) of FIG. 4 illustrates a state of a flotage when operation of the flotage is off, and (b) of FIG. 4 illustrates a state of the flotage when operation of the flotage is on.

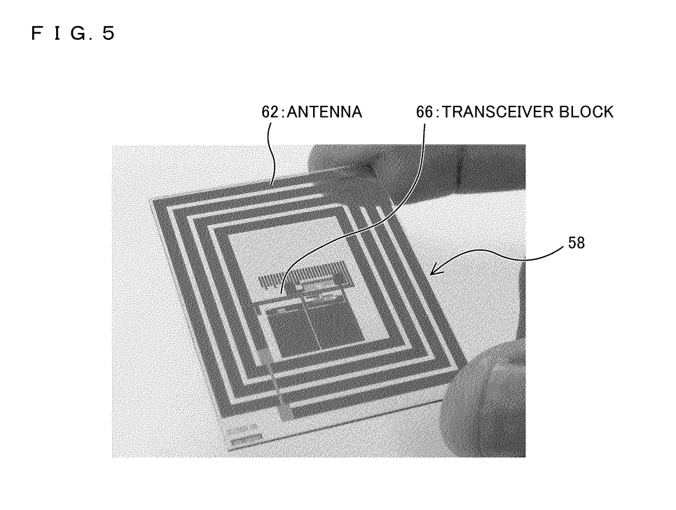

Moreover, FIG. 5 is a view illustrating a mounted example of a flotage on a glass substrate.

(Operation System)

As illustrated in FIG. 1, the operation system 10 of the present embodiment includes a peer 20 serving as an operation host section, connected to a home server inside a residence, and a flotage 50 serving as an operation terminal, for operating various apparatuses (operated apparatus) inside the residence via the home server.

A feature of the operation system 10 is that the peer 20 communicates with the flotage 50 in a non-contact manner within a short distance, for example within 5 cm, or within 2 cm. More specifically, for example, an operation signal (operation signal) is exchanged by optical signals (illustrated in FIG. 1), radio signals, induction coupling (illustrated in FIG. 3) and the like, and power is exchanged by induction coupling, resonance coupling (illustrated in FIG. 3), and the like. In the embodiment, examples of the exchange of the operation signal are an up-link of a video signal from the peer 20 to the flotage 50 and a down-link of an input (control) sequence from the flotage 50 to the peer 20.

In FIG. 3, the transceiver 28 may be contained within the home server. Alternatively, the configuration may be one in which just a modulation signal of a base band is supplied from the home server, and modulation and demodulation is carried out directly under an antenna.

Further, a minimum constituent of the peer 20 is, as described in other drawings: a module of an “accessing function element” and an “electric supply function element” discharging an operation signal in the air, or one which this module is disposed in an array form. The accessing function element in a case of optical communication is a light emitting element section and a light receiving element section, and in a case where transmission is performed by radio waves, the accessing function is an antenna.

Moreover, in the operation system 10 which is the feature of the present application, this exchange is carried out in a non-contact manner, so no connection by use of FPC or the like is required between the peer 20 and the flotage 50.

(Optical Communication)

First described with reference to FIG. 1 is an example of a configuration in which the signal is communicated by use of light.

(Peer)

The peer 20 of the present embodiment is connected directly to the host system, in other words, to the controlled apparatus, or is connected to the home server. In a case of the home server, the peer 20 is connected to various apparatuses that are provided within the residence. In the embodiment, the apparatuses encompass, for example, lighting of a room and like apparatuses.

The peer 20 and the flotage 50 which operate the apparatuses via the peer 20 are configured so that optical communication is possible with respect to the operation signals. More specifically, the peer 20 includes for example a general-purpose LED 22 as the light emitting element, and for example a general-purpose photodetector 24 as the light receiving element.

(Flotage)

Next described is the flotage 50. The flotage 50 includes an active matrix type display made up of for example liquid crystal (LC), EL or the like, and a touch (area) sensor.

In peripheral parts of base material of the flotage 50 such as glass, a photodetector and receiver system 54, a transmitter system 52, and a thin film light emitter 56 using a nc-Si light emitting phenomenon or the like are provided.

A configuration example of the light emitter using the nc-Si light emitting phenomenon is illustrated in (a) of FIG. 2, and an integrated example on a thin film, of the light emitter integrated with other devices such as a transceiver circuit, is illustrated in (b) of FIG. 2.

Further, an up-link and down-link between the peer 20 and the flotage 50 are carried out via the photodetector and receiver system 54, transmitter system 52 and nc-Si light emitter 56, and via the LED 22 and photodetector 24.

Note that the configuration of the operation system 10 is not limited to the foregoing configuration. For example, power may be transferred by induction coupling, and the signal may be communicated by optical communication or by use of radio waves.

(Radio Communication)

Next described with respect to FIG. 3 is an example of a configuration in which the signal is communicated by use of radio waves.

(Peer)

As illustrated in FIG. 3, in a case where the flotage 50 and a host system 15 communicate with each other or the like by radio-wave coupling, the host system 15 includes, as constituents of the system: a control section 26 of a home server central processing section or a controlled apparatus; a host transceiver 28; and a host antenna 30 connected to the transceiver 28. The host antenna 30 is an element making up the peer 20.

Thereafter, from the control section 26 of the home server central processing section or controlled apparatus to the host transceiver 28, display system data and power (power) are sent, and from the host transceiver 28, an inputted sequence and a control and timing signal, each of which are obtained from the flotage 50 later described, are transmitted back.

(Flotage)

On the other hand, the flotage 50 includes, as a constituent of a system driving a display in a non-contact manner: a VSR (Very Short Range) transceiver system 58 integrated on a thin film, for example a silicon thin film such as CG silicon (Continuous Grain Silicon: Continuous Grain Silicon); and a touch sensor/display system 64. The VSR transceiver system 58 includes a transceiver 60 and a flotage antenna 62 connected to the transceiver 60.

The transceiver 60 receives from the peer 20, via a wireless channel, display system data and power.

Thereafter, the transceiver 60 transmits the display system data to the touch sensor/display system 64 and simultaneously supplies the power (power); and from the touch sensor/display system 64, a control and timing signal and an inputted sequence are transmitted back.

(Example of Operation System)

As described above, (a) and (b) of FIG. 4 illustrate examples of operations of the operation system 10; (a) of FIG. 4 shows a state of the flotage at a time when the operation of the flotage is off, and (b) of FIG. 4 shows a state of the flotage at a time when the operation of the flotage is on.

In the example of the operation system 10 illustrated in (a) and (b) of FIG. 4, the operation terminal (flotage) 50 is configured so as to have the VSR transceiver system 58 and the touch sensor/display system 64 be connected via a flexible printed wiring board 70. Further, the display system 64 is made up of an active matrix type liquid crystal display element (LCD). The display system 64 is not limited to the LCD, and is made up of, for example, EL or the like.

The touch sensor/display system 64 is operated by bringing the VSR transceiver system 58 close to the peer 20 in such a manner that the VSR transceiver system 58 overlaps the peer 20. Illustrated in (a) of FIG. 4 is a state in which the touch sensor/display system 64 and the VSR transceiver system 58 are separated from each other by at least 5 cm, whereby no display is viewed; whereas, in (b) of FIG. 4, display data (in the embodiment, a color bar is schematically displayed) is transmitted to the touch sensor/display system 64 and display is carried out once the VSR transceiver system 58 is brought to a position which overlaps the peer 20. When the touch sensor/display system 64 is operated by being touched (not illustrated), position information of where the fingertip is touched is transmitted to the peer 20 via the VSR transceiver system 58, and then the home server central processing section or the control section of the controlled apparatus controls the operation of the apparatus based on the position information.

(VSR Transceiver System)

Next described is the VSR transceiver system 58, with reference to FIG. 5. FIG. 5 is a view illustrating an example of the VSR transceiver system 58.

As illustrated in FIG. 5, the VSR transceiver system 58 of the present embodiment uses a glass plate as base material. On a center part of the glass plate, a transceiver block 66 is provided. Surrounding the transceiver block 66, a spiral flotage antenna 62 is provided.

A configuration taking the image display system of the peer 20 and the flotage 50 as an example is described in details later.

By use of the configuration as described above, power is transmitted from the peer 20 to the flotage 50 by induction coupling.

Moreover, operation signals such as a video signal or a control sequence can be transmitted from the peer 20 to the flotage 50 via light, radio waves, or light and radio waves.

Moreover, in the operation system 10 of the present embodiment, transmission between the peer 20 serving as the operation host section which is the accessing means and the flotage 50 serving as the operation terminal of the power and signals is performed just in a limited distance as described earlier; more specifically, within a range of not more than 5 cm or not more than 2 cm. Hence, security against interception or the like is high, and electricity consumption can be reduced in amount.

In the operation system of the present invention, an energy transfer rate of the power is approximately 10% or more, or approximately 60% or more under a short-distance operation limitation.

Moreover, since the power is supplied from the peer 20, no independent power source is required in the flotage 50. This allows reducing the thickness and weight of the flotage 50.

The flotage 50 may include a simplified power storage capable of continuously operating for a short-term at a time when the power supply is interrupted or is outside the power supplied range. Examples of the simplified power storage encompass a polymer sheet type secondary battery, a large-scale condenser, and a button battery. By including the simplified power storage, it is possible to broaden the operational range of the operation terminal without losing the light weight and thinness of the flotage 50.

(Disposition of Peer)

Next described is a disposition example of the peer 20, as the operation host section.

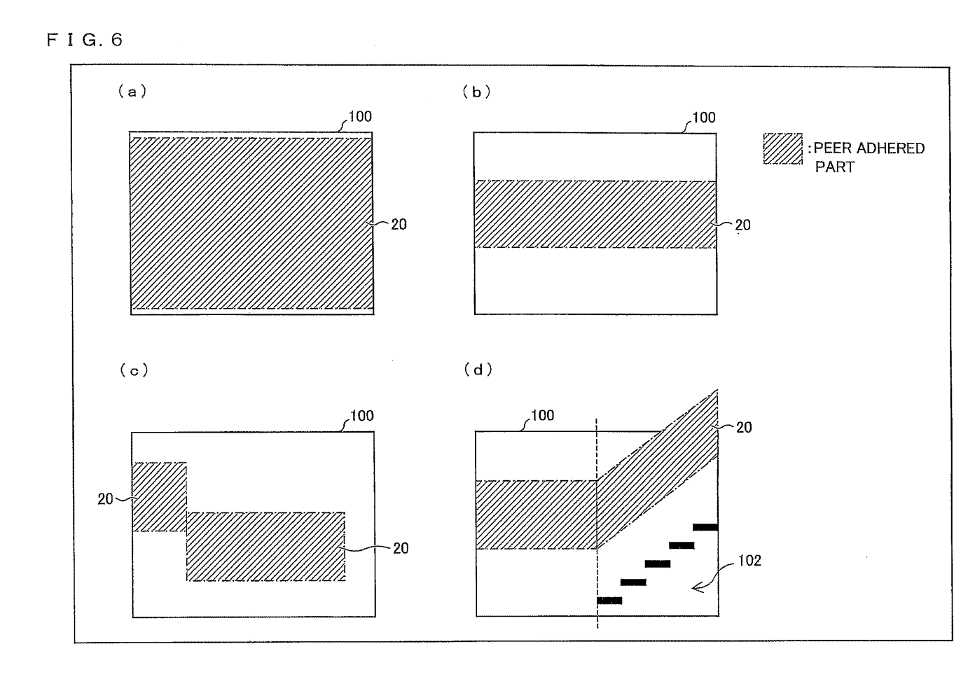

Illustrated in (a) to (d) of FIG. 6 are views of examples of how the peer 20 is disposed on a wall 100, from a plan view perspective.

As illustrated in (a) to (d) of FIG. 6, the peer 20 may be disposed on the wall 100 in various positions. By disposing the peer 20 on the wall 100, the wall becomes a wall material having an accessing function. In the following description, the embodiment is explained by use of an operation host section that is shaped as a substrate and is provided on a substrate, as the foregoing operation host section.

(Entire Surface)

First described is a disposition example illustrated in (a) of FIG. 6. In this disposition example, the peer 20 is disposed on substantially an entire surface of the wall 100.

In a case where the peer 20 is disposed as such, the operation by the flotage 50 can be carried out from anywhere near the wall 100. Namely, this can be said as a disposition of the peer 20 that is completely free in layout.

(Western-Style Room, Corridor, Etc.)

Next describes a disposition example illustrated in (b) of FIG. 6. In this disposition example, the peer 20 is provided in a position near a part midway of the wall 100 in a vertical direction, so as to extend in a horizontal direction in a band form.

In a case where the peer 20 is disposed as such, it is not possible to carry out operation by use of the flotage 50 near an upper edge and a lower edge of the wall 100 in the vertical direction.

Accordingly, this configuration allows preventing the flotage 50 from being inadvertently started in operation, for example in a case of preventing a child not tall in height from touching the peer 20. Moreover, it is possible to prevent the apparatus from being (mal)functioned by a child operating the flotage 50.

Moreover, in a western-style room in which no person usually sits or lies down directly on the floor, it is unusual to come to an idea of taking a posture to operate a lighting or the like around the floor. As such, it is possible to dispose no peer for parts corresponding to a region in which an object for operation would be disposed at an extremely low possibility due to room characteristics. Similarly, it is considered that disposition of the peer near the floor on which no person usually sits down while passing can also be omitted. By disposing no peer 20 near an upper edge of the wall 100 of a corridor, which upper edge is usually not used frequently, it is possible to reduce the costs required for disposing the wall material that has an accessing function.

The disposition of (not a whole but a part of) the peer 20 as described above is suitably utilized in, for example, a children's room used by a little child, a western-style room, and a corridor.

(Japanese-Style Room and Bathroom Etc.)

The following describes a disposition example illustrated in (c) of FIG. 6. In this disposition example, two substantially rectangular peers 20 are disposed on the wall 100.

In this disposition example, for example near an entrance of a room, the peer 20 is disposed in a relatively high position so that the peer 20 is suitably accessible in a state in which a person is standing to operate the flotage 50.

Furthermore, near a center part of the room, the peer 20 is disposed on a relatively low position so that a person can access the peer 20 from the flotage 50 in a sitting state.

As described above, by disposing the peers 20 in accordance with a chiefly used mode of the room, it is possible to achieve a disposition of the peer 20 which causes few malfunctions, at low costs.

The peer 20 illustrated in (c) of FIG. 6 may be initially formed as a desired shape (a cut-out single piece), or two pieces of rectangular peers 20 may be connected to each other via a jumper wire.

Such a disposition of the peer 20 is suitably used in a room in which a user takes a low posture, for example in a Japanese-style room or a bathroom.

(Staircase, Etc.)

Next described is a disposition example illustrated in (d) of FIG. 6. In this disposition example, a band shaped peer 20 is disposed diagonally on the wall 100.

In the foregoing disposition example, for example with a staircase 102, the peer 20 is disposed diagonally in accordance with an inclination of the staircase 102.

Further, no peer 20 is disposed on parts in which no access from the flotage 50 is assumable, such as a space below the staircase 102. This allows efficient disposition of the peer 20.

(Flotage)

The flotage 50 which is the operation terminal may be permanently disposed on the wall 100 in a semi-fixed manner by use of adhesive material serving as a fixing device, or alternatively, if necessary, may be brought close to the wall 100, namely near the peer 20, while holding the flotage 50 in their hands, or be temporally attached by use of the adhesive material similarly serving as a fixing device.

Moreover, by having the adhesive material serve as the fixing device, it is possible to easily add a repetitive function to the fixing device, which allows repetitively carrying out the fixing and detaching.

An example of permanently disposing the flotage 50 in a semi-fixed manner to the wall 100 is one in which the flotage 50 is used to serve as a switch of a lighting. The switch of the lighting is preferably positioned at a same position and not moved around while a room configuration is set, since it is easily possible to assume and identify its position unconsciously or in the dark.

On the other hand, an example of disposing the flotage 50 as necessary on the wall 100 is an example in which the flotage 50 is used as an interphone inside a bathroom (doorphone terminal or terminal like a general-purpose home video window). A possible utilization mode in this case is that the terminal is usually carried by the user and its function is used by bringing the flotage 50 close to the wall as necessary. In this case, the flotage 50 is disposed in any position on the wall 100 that is easy to view for the user, to be operated by the user.

(Disposition of Peer)

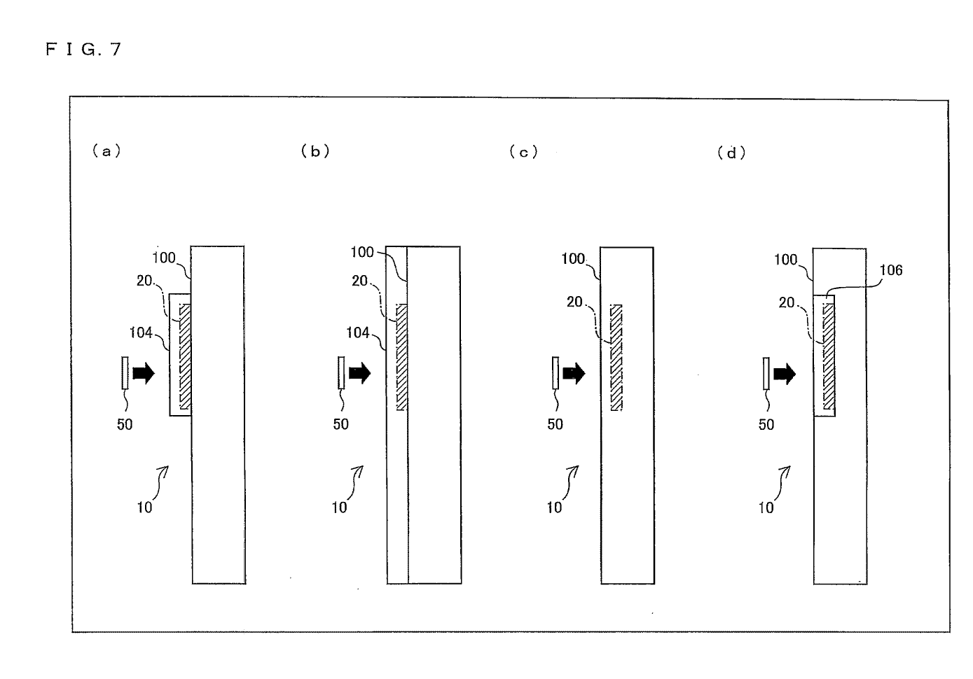

Next described is a typical method of disposing the peer 20, with reference to (a) to (d) of FIG. 7. Illustrated in (a) to (d) of FIG. 7 are views of how the peer 20 is disposed on the wall 100, from a cross-sectional view perspective.

Each of these views are schematic views for providing a description, and their depicted thickness, size and the like of the wall 100 and other members do not accurately reflect an actual ratio of those members.

(Posterior Adhesion (Partial))

First described is a disposition example illustrated in (a) of FIG. 7. In this disposition example, the peer 20 (peer function section) is disposed on one part of the surface of the wall 100. Further, a skin member 104 is provided to cover the peer 20.

In this disposition example, the peer 20 can easily be disposed on the wall 100 that is constructed beforehand. Moreover, by covering the peer 20 with the skin member 104, it is possible to dispose the peer 20 at a latter stage, without spoiling the fine appearance. This also protects the peer 20 from careless damage. Furthermore, it is possible to avoid accidents such as an electric shock accident from occurring, even if an electrode part is exposed due to a defect.

Moreover, since the skin member 104 is provided on just the parts on which the peer 20 is disposed, it is possible to clearly indicate the position of the peer 20 to the user.

(Posterior Adhesion (Entire Surface))

Next described is a disposition example illustrated in (b) of FIG. 7. This disposition example is similar with the disposition example illustrated in (a) of FIG. 7 in that the peer 20 (peer function section) is disposed on one part of the surface of the wall 100.

However, the disposition example differs from that of (a) of FIG. 7 in how the skin member 104 is provided. Namely, in the disposition example of (a) of FIG. 7, the skin member 104 is provided on just the parts covering the peer 20; whereas in the disposition example of (b) of FIG. 7, the skin member 104 is provided on an entire surface of the wall 100.

In this disposition example, the entire wall 100 is covered with the skin member 104. Hence, it is difficult to identify that the peer 20 is disposed on the wall 100. Consequently, by uniformly coating or decorating the skin member 104, it is possible to hold down the deterioration in the fine appearance caused by disposing the peer 20 on the wall 100. Meanwhile, on the contrary, it is possible to unobtrusively indicate the position of the peer 20 without losing the fine appearance of the room by appropriately and beautifully decorating or coating the display member 104 so that the position of the peer 20 is intentionally indicated.

(Inclusion to Wall Material)

Next described is a disposition example illustrated in (c) of FIG. 7. In this disposition example, different from the disposition examples of (a) and (b) of FIG. 7, the peer 20 is embedded inside the wall 100 in advance.

In this disposition example, different from the disposition examples that posteriorly attach the peer 20 on the surface of the wall 100, no unevenness is generated on the surface of the wall 100, and no skin member 104 is necessarily provided on the surface of the wall 100.

Accordingly, it is possible to dispose the peer 20 on the wall 100 without being noticed by its external appearance that the peer 20 is provided on the wall 100. Moreover, it is possible to ideally design the room without having to thicken the wall material to a thickness not less than an initial value. Needless to say, by preparing a wall material that has a decoration on its surface which indicates a position of the peer 20, which wall material is decorated appropriately having a fine appearance, it is possible to unobtrusively indicate the position of the peer 20. In either case, it is possible to design the fine appearance of the room as desired.

(Preprocessed Wall Material)

Next described is a disposition example illustrated in (d) of FIG. 7. This disposition example is similar with the disposition example illustrated in (c) of FIG. 7 in that the peer 20 is disposed inner of the wall 100.

However, the disposition example illustrated in (d) of FIG. 7 has the peer 20 disposed inside a depression 106 formed on the wall 100.

Further, although it is not always required, the skin member 104 is provided on the depression 106 so as to cover the peer 20 disposed inside the depression 106 and to fill in the depression 106.

The depression 106 may be formed on the wall 100 in advance, or may be formed on the wall 100 after the disposition of the peer 20 is decided. Moreover, a configuration which employs as the wall material 100 a configuration allowing formation of such a depression 106 at a later stage may also serve as a feature.

More specifically, for example, broken section lines may be provided in advance to the wall material 100, or a wall agent 100 may be made of material which allows easy hollowing.

Moreover, in a case where the skin member 104 is provided on the depression 106, a preferable decoration may be selected to clarify the position of the peer 20. Moreover, the depression 106 is filled with the skin member 104; this allows avoiding generation of a step on the surface of the wall 100.

Thickness of the skin member 104 illustrated in the drawings can be extremely thin. For example, it is preferable to use paper for use on walls, resin sheets, or decorative laminates, each of which has a thickness of up to several millimeters at the most.

Moreover, the disposition examples illustrated in (a) to (d) of FIG. 7 just illustrate typical disposition examples of the peer 20 in a “western-style room, corridor etc.” illustrated in (b) of FIG. 6.

Hence, even in cases where the peer 20 is disposed on a different position on the wall 100 from a plan view perspective, it is possible to dispose the peer 20 on the cross-sectional positions illustrated in (a) to (d) of FIG. 7.

Moreover, for example, particularly in the disposition examples illustrated in (a) to (d) of FIG. 7, by appropriately carrying out a characteristic decoration on the skin member 104 as described before, it is possible to easily provide the user with means clearly indicating the position of the peer 20, while allowing posterior modifications and without losing its fine appearance.

(Disposition of Peer)

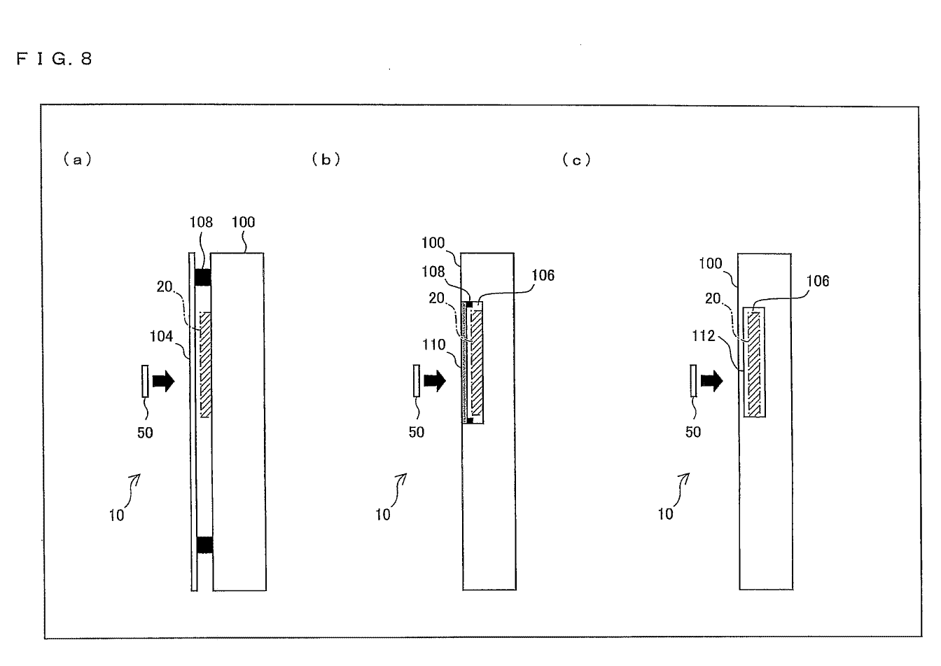

Next described is another typical example of how to dispose the peer 20, with reference to (a) to (c) of FIG. 8. Illustrated in (a) to (c) of FIG. 8 are views of how the peer 20 is disposed on the wall 100 from a cross-sectional view perspective.

These drawings are schematic views for providing descriptions, and the thickness, size and the like of the wall 100 and the like do not accurately reflect their actual ratios.

(Gap Disposition)

A disposition example illustrated in (a) of FIG. 8 is similar with the disposition example illustrated in (a) of FIG. 7 in that the peer 20 (peer function section) is disposed on the surface of the wall 100.

However, in the disposition example illustrated in (a) of FIG. 7, the skin member 104 is provided directly on the surface of the peer 20 so as to cover the peer 20. In comparison, in the disposition example illustrated in (a) of FIG. 8, the skin member 104 is not directly provided on the peer 20 but is provided on the surface of the wall 100 via at least one beam 108. Further, in the disposition example illustrated in (a) of FIG. 8, the skin member 104 covers the peer 20 without being in contact with the peer 20.

The skin member 104 may be provided so as to be in contact with the peer 20. The skin member 104 can be made in contact with the surface of the peer 20; however, in order to clearly depict that the skin member is being held by the beam 108, (a) of FIG. 8 illustrates a state in which the skin member is not in contact with the peer.

The beams 108 are not particularly limited in its shape or material. A typical example of the beams 108 is material of a cylindrical shape or square timber. It is possible to use a narrow square timber as the beam 108 by placing the square timber as a crossbeam.

In the foregoing disposition example, it is possible to easily redispose the peer 20 and also easily change a disposed position of the peer 20.

Moreover, in the disposition example illustrated in (a) of FIG. 8, the skin member 104 covers substantially the entire surface of the wall 100. In this disposition example, it is difficult to identify that the peer 20 is disposed on the surface of the wall 100.

The skin member 104 not necessarily covers the entire wall 100, and may be configured so as to cover, for example, just the peer 20 via the beams 108.

Moreover, the beams 108 can be provided on either direction of the wall 100, and may be provided in, for example, a horizontal direction, a vertical direction, or a mixture of these directions. Namely, as long as the disposition of the beams 108 does not obstruct the peer 20, any method is possibly taken.

Moreover, a gap generated between the surface of the wall 100 and the skin member 104 via the beams 108 may be provided to the wall material in advance, or the beams 108 may be added to the wall 100 at a later stage, so as to generate a gap between the skin member 104 serving as a surface plate and the wall 100. Attainment of similar effects is expected as with (a) of FIG. 7, as to effects attained by the surface decoration of the skin member 104.

(Preprocessed Wall Material)

Next described is a disposition example illustrated in (b) of FIG. 8. This disposition example is similar with (d) of FIG. 7 in that the peer 20 is disposed in the depression 106 formed on the wall 100.

However, in the disposition example illustrated in (b) of FIG. 8, beams 108 are provided inside the depression 106, and via these beams 108, the depression 106 is covered by a covering material 110. Namely, a covering material 110 having substantially a same size as an opening of the depression 106 is provided on the beams 108, whereby the depression 106 is covered.

With this disposition example, it is possible to improve the decorativeness of the wall 100 by freely selecting the design and the like of the covering material 110. In this view also, a same effect as the mode illustrated in (d) of FIG. 7 can be expected as to the effect attained by decorating a surface of the covering material.

Moreover, the depression 106 is covered by the covering material 110. Hence, it is possible to provide a flat and smooth surface of the wall 100 which has no steps.

(Wall Inner Slit)

Next described is a disposition example illustrated in (c) of FIG. 8. In this disposition example, a slit-shaped space 112 is opened in the wall 100, and the peer 20 is disposed inside this slit-shaped space 112. The slit-shaped space 112 in the embodiment is a hollowed space inside the wall 100.

According to this disposition example, no hole or step is formed on the surface of the wall 100. As a result, it is possible to dispose the peer 20 without deteriorating the decorativeness of the wall.

The disposition and replacement of the peer 20 into the slit-shaped space 112 may be carried out, for example, from an opening of a slit on an edge surface of the wall 100.

(Control and Disposition of Peer)

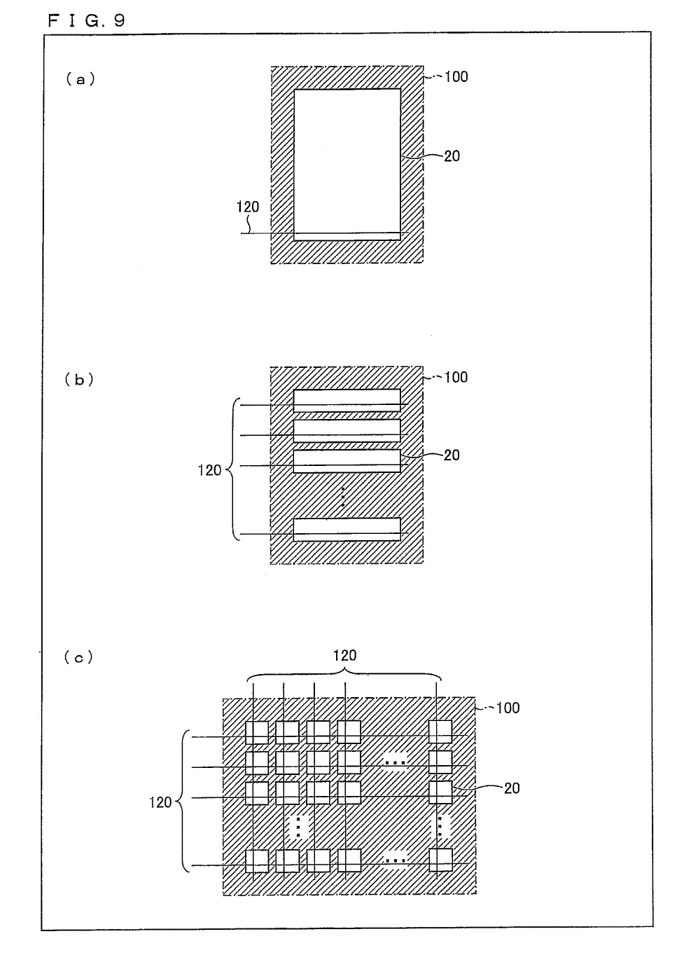

The following description deals with controlling and disposing the peer 20, with reference to (a) to (c) of FIG. 9.

In the embodiment, (a) to (c) of FIG. 9 are views illustrating how the peer 20 is disposed on the wall 100, from a plan view perspective.

(No Controlling of Active Position)

First described is a disposition example of the peer 20, which is illustrated in (a) of FIG. 9. In this disposition example, one piece of the peer 20 is disposed on substantially an entire surface of the wall 100. Further, a driving line 120 is connected to the peer 20, which driving line is connected to a home server for example.

With such a disposition example, the substantially entire surface of the wall 100 is in an accessible state.

(One-Dimensional Position Control)

Next described is a disposition example of the peer 20, illustrated in (b) of FIG. 9. Different from the peer 20 illustrated in (a) of FIG. 9, in this disposition example, the peer 20 is divided into a plurality of pieces. In other words, the substantially entire surface of the wall 100 is covered by a plurality of pieces of the peer 20.

More specifically, a plurality of roughly strip-shaped peers 20 are disposed parallel to each other, having their longitudinal directions run along a horizontal direction of the wall.

Further, on the wall 100, a plural number of the driving line 120 which are connected to the peers 20, respectively, are provided in a direction parallel to the longitudinal direction of the peers 20.

By providing the peers 20 as such, it is possible to carry out what is called “one-dimensional position control”.

Namely, different from the disposition example illustrated in (a) of FIG. 9 in which one piece of the peer 20 is disposed on substantially the entire surface of the wall 100, it is possible to selectively access just a part where necessary, among the pieces of the peer 20 disposed on the wall 100.

The foregoing description explains a configuration in which the longitudinal direction of the peers 20 and the direction of the driving lines 120 run in the horizontal direction. However, these directions are not limited to be running in the horizontal direction, and may be running in a vertical direction, for example. Moreover, the peers are not necessarily strip-shaped; as long as the peers are positioned so as to be desirably driven in sections in a linear direction, the configuration may be one in which the peers of a fan shape or a partial circle shape are disposed in a circumferential direction. Moreover, the peers are not necessarily all in identical shapes or identical sizes. If a region that is desirably driven as a whole is large but is desirably controlled minutely, small peers may be disposed. Moreover, peers of a suitable size may be selected in consideration of a difference in electricity consumption due to a function scale of the flotage. By driving just the required peers, it is possible to further reduce standby power consumption that is expected of the peers, to some extent. This as a result allows providing an operation system more in line with energy conservation.

(Two-Dimensional Position Control)

Next described is a disposition example of the peer 20, illustrated in (c) of FIG. 9. In this disposition example, the peer 20, different from the peer 20 illustrated in (b) of FIG. 9, is divided into a plurality of pieces of the peer 20 not just in one direction but in two directions. In other words, the substantially entire surface of the wall 100 is covered by having a plurality of pieces of the peer 20 disposed thereon, so that the plurality of pieces of the peer 20 form a matrix.

More specifically, a plurality of pieces of roughly square-shaped peers 20 are disposed as a grid.

Furthermore, a plurality of driving lines 120 are provided on the wall 100 in a lattice form so as to run in a vertical direction and in a horizontal direction, which driving lines 120 are connected to respective peers 20.

By disposing the peers 20 as such, it is possible to carry out what is called a “two-dimensional position control”.

Namely, as compared to the configuration in which the plurality of pieces of the strip-shaped peers 20 are disposed so as to be long in the horizontal direction of the wall 100, it is possible to selectively access the position of just the necessary part, among the peers 20 disposed on the wall 100. The effects attained and the conditions of the shape of the peers are the same as those of the one-dimensional case; this configuration further makes it possible to carry out optimistic disposition of the peer 20, which improves economic properties.

Positions at which the driving lines 120 are pulled out in each of the disposition examples are not particularly limited. For example, it is possible to employ various methods such as focusing on one side or accessing from four sides.

(Configuration of Peer)

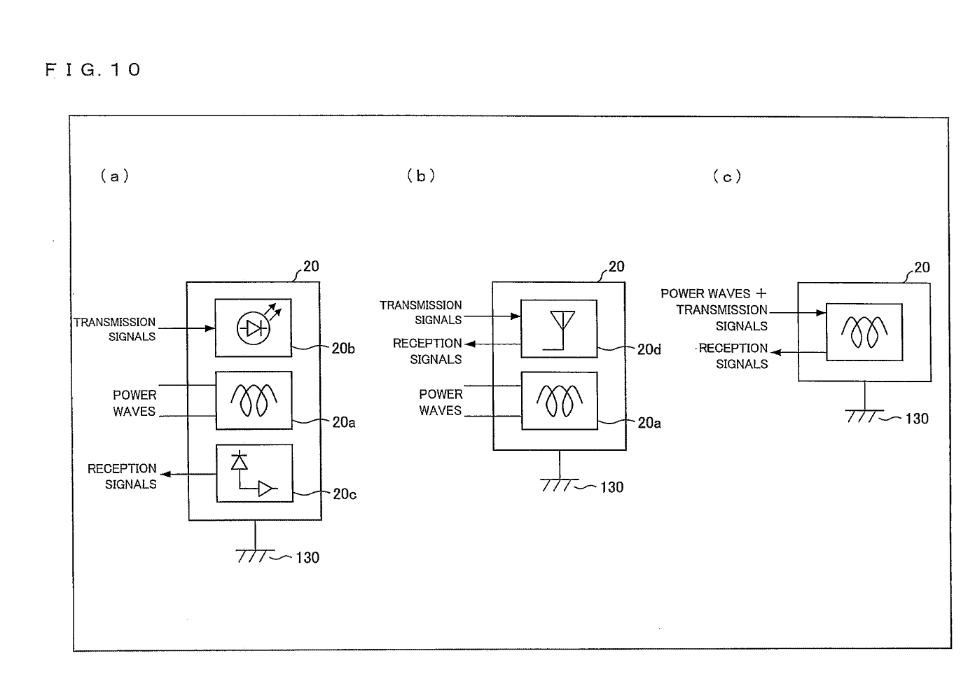

Next described is a configuration of the peer 20, with reference to (a) to (c) of FIG. 10.

In the embodiment, (a) to (c) of FIG. 10 illustrate an embodiment of the present invention, and are schematic views illustrating configurations of a peer.

(Example of Light Transmission and Reception)

First described is a configuration illustrated in (a) of FIG. 10. In this configuration, power is transmitted via power waves, and operation signals are transmitted and received via light, between the peer 20 (accessing and electric supply function element) and the flotage.

The peer 20 includes an electric supply element section 20a, a light emitting element section 20b and a light receiving element section 20c.

The electric supply element section 20a supplies the power to the flotage via the power waves.

Moreover, the light emitting element section 20b transmits signals such as the operation signals to the flotage, as light. On the other hand, the light receiving element section 20c receives the optical signals transmitted from the flotage.

As described above, between the peer 20 and the flotage of the above configuration, power is supplied in a non-contact manner, and signals are transmitted and received via light.

The transmission of the signals is not necessarily carried out in a two-way transmission and reception; the transmission and reception may be carried out one-way in accordance with the configuration of the operation system.

The optical transmission and reception may be carried out by use of invisible light having an emitted light intensity of not more than 0.1 W/m². Intense light may rather serve as inconvenient, in keeping an area detectable by the light receiving element of the flotage to be within around several centimeters from the wall on which the peer is disposed.

Moreover, in a case where infrared light is used as the light for the optical transmission and reception, the light becomes invisible for humans.

Alternatively, in a case where the light has the intensity visible to the eye, the light may be actively used as a part of a decoration of the wall. More specifically, the light may be used as a decoration by displaying an arbitrary pattern, for example by thinking of a position of a light source later described or by providing a plurality of the light source and selectively lighting some of the light sources among the plurality of lights.

Furthermore, in a case where wavelengths of light emission from the peer (wall) and light emission from the flotage are remarkably changed, it is possible to carry out transmission and reception while avoiding any interference occurring between each other. More specifically, the wavelength of the light from the peer may be around 500 nm, whereas the wavelength of the light from the flotage may be around 800 nm, for example.

In the case of the transmission and reception using light, it is possible to eliminate the possibility that law regulations are internationally applied, for a remarkable range. Hence, this allows providing a mode that is easily applied industrially.

(Example of Radio Wave Transmission and Reception)

Next described is a configuration illustrated in (b) of FIG. 10. In this configuration, the power and the operation signals are both electrically transmitted between the peer 20 (accessing and electric supply function element) and the flotage. Namely, the power is supplied from the peer 20 to the flotage via power waves, and the operation signals are transmitted and received via radio waves.

The peer 20 includes the electric supply element section 20a and an antenna section 20d. Namely, the antenna section 20d for transmitting and receiving the radio waves is provided instead of the light emitting element section 20b and the light receiving element section 20c illustrated in (a) of FIG. 10.

By electrically transmitting both the power and the operation signals, it is possible to simplify the configuration of the peer 20.

(Example of Inductive Coupling Transmission and Reception)

Next described is a configuration illustrated in (c) of FIG. 10. In this configuration, being similar to the configuration illustrated in (b) of FIG. 10, both the power and the operation signals are transmitted electrically between the peer 20 (accessing and electric supply function element) and the flotage, more specifically by inductive coupling (induction coupling).

However, in the configuration illustrated in (b) of FIG. 10, the peer 20 is provided with two elements, the electric supply element section 20a for transmitting the power and the antenna section 20d for transmitting and receiving the operation signals. In comparison, the configuration illustrated in (c) of FIG. 10 just includes the electric supply element section 20a.

By this electric supply element section 20a, the power waves and transmission signals are transmitted, and reception signals are received.

A specific example of such a transmission and reception is, for instance, a method in which signals are falsely transmitted two-way from a configured flotage to the peer so that signals are transmitted by using waves for supplying electricity as carrier waves and modulating this with the operation signals, and that a load impedance is actively changed, by providing to the peer a function that detects a change in load as a change in electric current of a power source of a constant-voltage power source. More specifically, a configuration example may be one which includes a load impedance modulation section in the flotage, which section is capable of changing the load, and which includes a load modulation detection section in the peer, which section detects a change in electric current flowing in the constant-voltage power source caused by the change in the load.

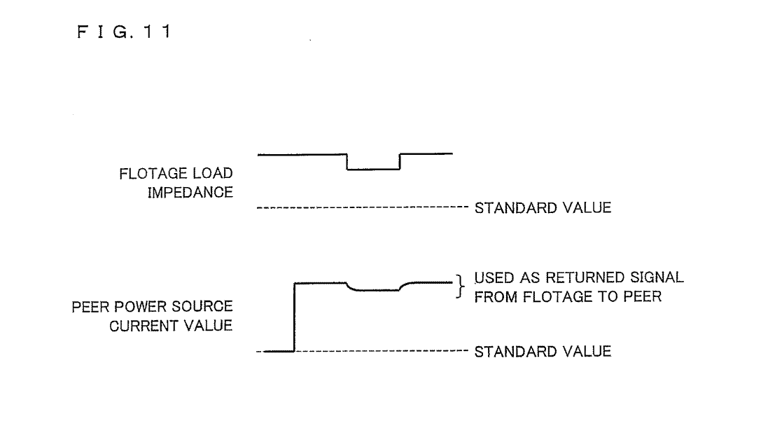

As illustrated in FIG. 11, a change in the load impedance of the flotage causes a change in the power source current value of the peer. This change can be used as a returned signal from the flotage to the peer.

(Electric Supply Function Element)

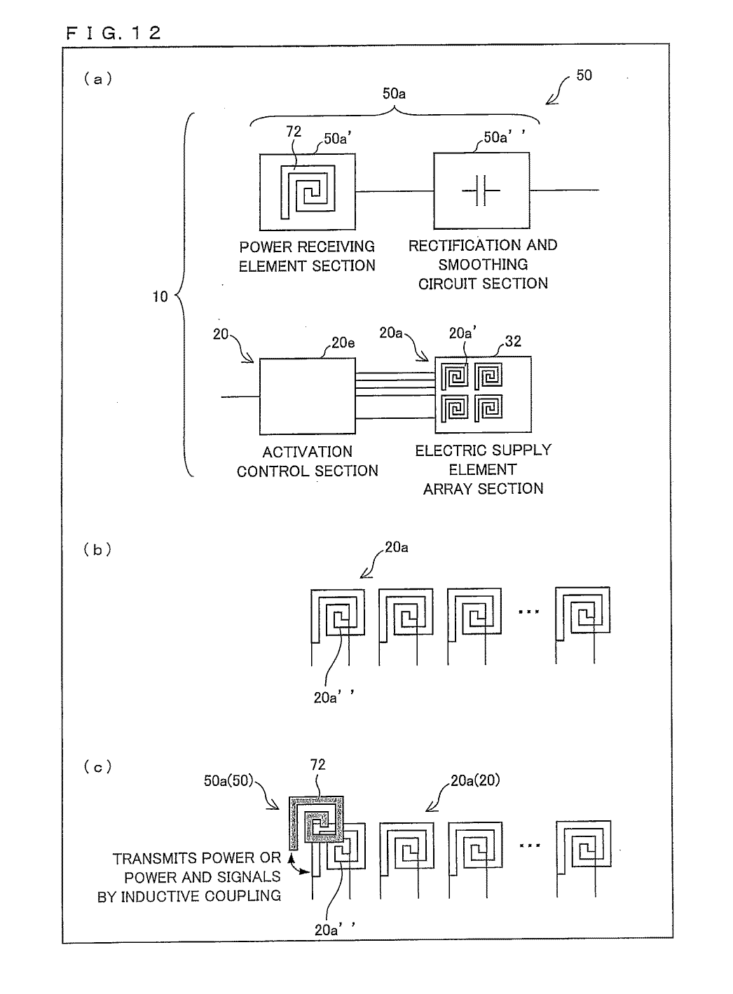

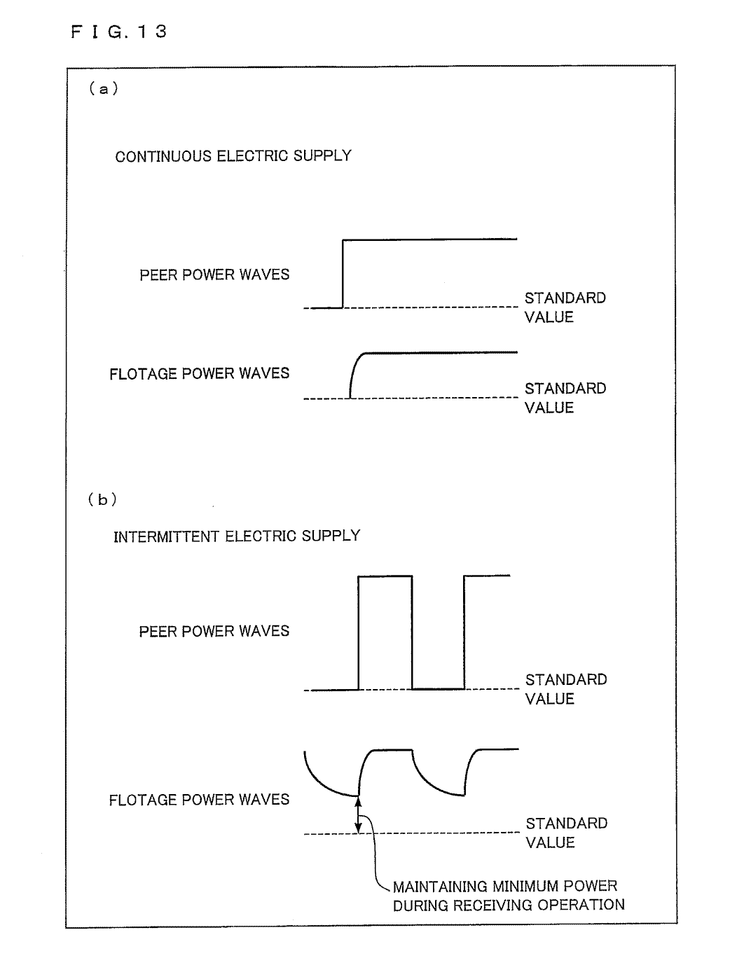

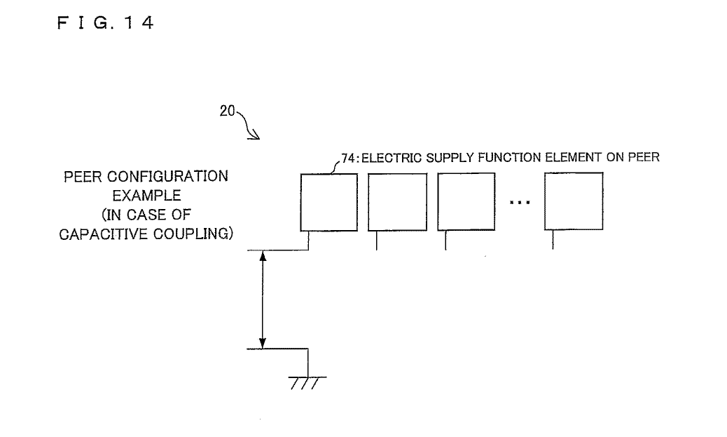

Next described is the electric supply element section 20a of the peer 20, with reference to (a) to (c) of FIG. 12, (a) to (c) of FIG. 13, and FIG. 14.

In the embodiment, (a) to (c) of FIG. 12 are views schematically illustrating configurations of elements related to electric supply, such as the electric supply element section 20a and like elements. Moreover, (a) of FIG. 13 is a view illustrating waveforms of a continuous electric supply, and (b) of FIG. 13 is a view illustrating waveforms of an intermittent electric supply.

As illustrated in (a) of FIG. 12, the peer 20 of the operation system 10 in the present embodiment includes an activation control section 20e and an electric supply element section 20a. The electric supply element section 20a has an electric supply element array section 32 in which a plurality of peer dielectric elements 20a′ are provided. The peer dielectric elements 20a′ correspond to respective accessing and electric supply function elements illustrated as the peer 20 in (b) or (c) of FIG. 8.

On the other hand, the flotage 50 includes a receiver 50a that includes a power receiving element section 50a′ and a rectification and smoothing circuit section 50a″. Further, the power receiving element section 50a′ includes a flotage dielectric element 72.

More specifically, as illustrated in (b) of FIG. 12, the electric supply element section 20a of the present embodiment includes the peer dielectric element 20a′ or a resonating element (not illustrated since it is simply a replacement and its disposition is similar), depending on the transmitting means of the power between the peer and the flotage. The peer dielectric element 20a′ is shaped of a coil, and a plural number of the peer dielectric element 20a′ is formed in the electric supply element section 20a.

As illustrated in (c) of FIG. 12, when the flotage dielectric element 72 provided in the flotage 50 is brought close to the electric supply element section 20a, a peer dielectric element 20a′ disposed close to the flotage dielectric element 72 becomes active among the plurality of pieces of the peer dielectric elements 20a′ (active dielectric element 20a″).

Thereafter, caused by the dielectric coupling between the flotage dielectric element 72 and the active dielectric element 20a″, the transmission of the power or the power and signals (operation signals) is carried out.

(Electric Supply Waveform)

How the electric power is supplied to the peer and the flotage to enable the transmission is not particularly limited in the embodiment, however an electric supply method illustrated in (a) and (b) of FIG. 13 is an example of carrying out control in a time direction.

Namely, a waveform illustrated in (a) of FIG. 13 illustrates what is called a continuous electric supply. In this continuous electric supply, the peer power waves and the flotage power waves are maintained at a substantially fixed electric potential.

On the other hand, a waveform illustrated in (b) of FIG. 13 illustrates what is called an intermittent electric supply.

In the intermittent electric supply, the peer power wave is, for example, a rectangular wave or a sawtooth wave.

This intermittent electric supply allows control of the waveform in time divisions. Signal transmission from the flotage to the peer during, for example, an interval in which transmission of power waves is paused, allows appropriate reception of the power waves and received signal while avoiding the power waves and received signal to be mixed together on the peer antenna. As a result, it is possible to easily switch between the transmission and reception.

(Capacitive Coupling)

Next schematically describes a case of using capacitive coupling as another configuration of the electric supply function element, with reference to FIG. 14. In the embodiment, FIG. 14 illustrates an example of a configuration of the peer, in capacitive coupling.

As illustrated in FIG. 14, in a case where the power and signals are transmitted by capacitive coupling, the peer 20 is configured so that a capacitative element is constructed between the peer 20 and the flotage, as an electric supply function element 74 on the peer. More specifically, an example of this is a configuration in which a flat-plate electrode is provided on both the peer 20 and the flotage.

Either capacitive or inductive, in a case where an intensity of a set electricity (power) transmission and of a signal is attained, the elements do not need to be all identical types. Moreover, it is possible to combine the capacitive and inductive coupling. Furthermore, material of a used pole plate, a winded state of a used coil, and like states are not necessarily identical between adjacent elements.

Moreover, it is possible to select the accessing and electric supply function element to be made active, in a method same as that according to a returned signal caused by a change in the load. Namely, control is performed so that just the accessing and electric supply function element on which load is applied or just the accessing and electric supply function element and its vicinity is made active. Moreover, a proximity sensor according to another configuration may also be provided.

Furthermore, in a case where the standby power consumption can sufficiently be ignored, for example when no power receiving coil of the flotage which serves as a secondary member in the inductive coupling exists, and the electric current flowing in the primary peer coil is minute, there is no need to particularly perform activation control. In a case where no activation control is performed, although its operation is not particularly illustrated, all the electric supply elements are always active as in the case of (a) of FIG. 9.

(Surface of Optical Transmission and Reception)

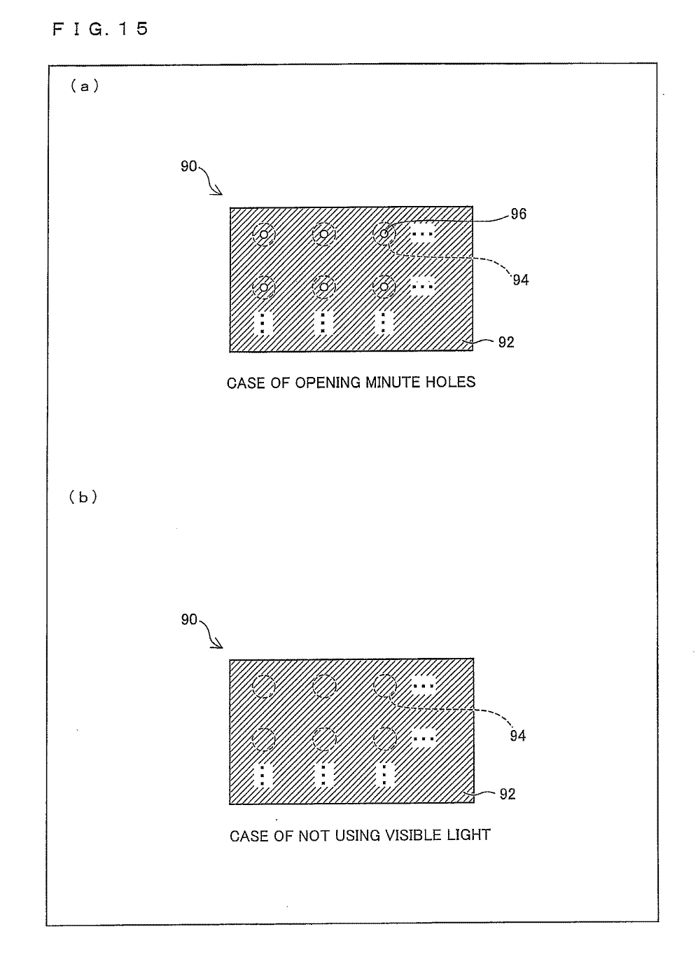

The next description deals with a transmitting and receiving part when transmission and reception via light is carried out, with reference to (a) and (b) of FIG. 15.

In the embodiment, (a) and (b) of FIG. 15 are views illustrating examples of embodiments of the present invention, and are views schematically illustrating an optical transmission and reception surface.

Illustrated in (a) of FIG. 15 is an external appearance of a cover 92 made of for example paper, wood, or resin, which cover is provided on the optical transmission and reception surface 90.

As illustrated in (a) of FIG. 15, light sources such as an LED used for the optical transmission and reception are disposed respectively on light-emitting light-receiving element disposing sections 94 disposed so as to form a matrix. Further, each of the light-emitting light-receiving element disposing sections 94 has a minute transmission and reception light hole 96. The disposition of the light-emitting light-receiving element disposing sections 94 are not limited to the matrix form, and may be disposed so as to be aligned in an indeterminate form in a one-dimensional or two-dimensional direction, as in the description with reference to FIG. 8.

The light is transmitted and received through the transmission and reception light hole 96. Moreover, in the configuration illustrated in (a) of FIG. 15, a decoration may be formed by use of light of a light source in a case where visible light is used as the light source, or the like.

Moreover, as illustrated in (b) of FIG. 15, in a case where no visible light is used, it is possible to open no transmission and reception light hole 96 on the cover 92. In this case, if for example infrared light is used as the light source, the cover 92 may be provided by use of resin which passes through the infrared light. As long as the cover 92 is arranged appropriately in terms of appearance and is acceptable in terms of aesthetic sense of a user, the cover 94 may be used which passes through visible light in a case where the light is the visible light, that is, of a transparent or semitransparent cover 92.

(Flotage)

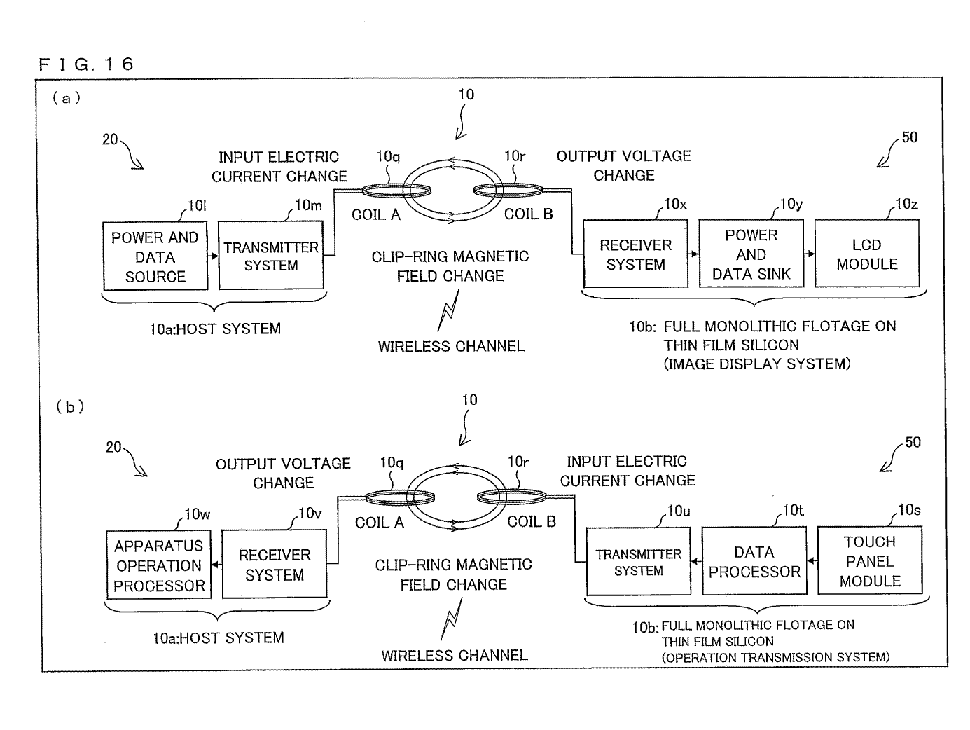

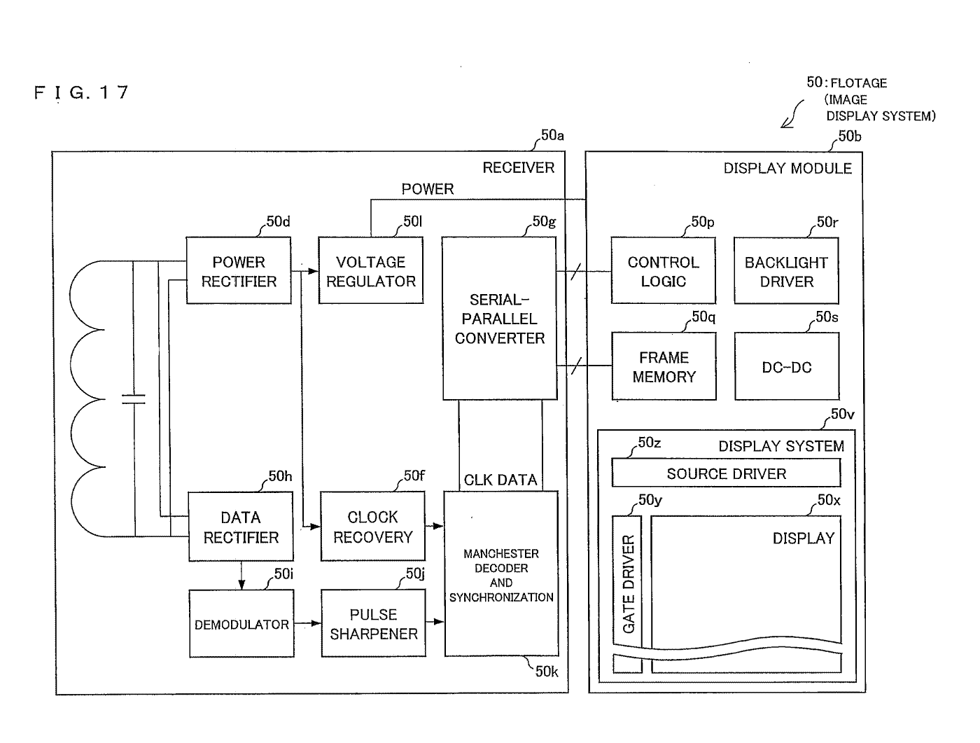

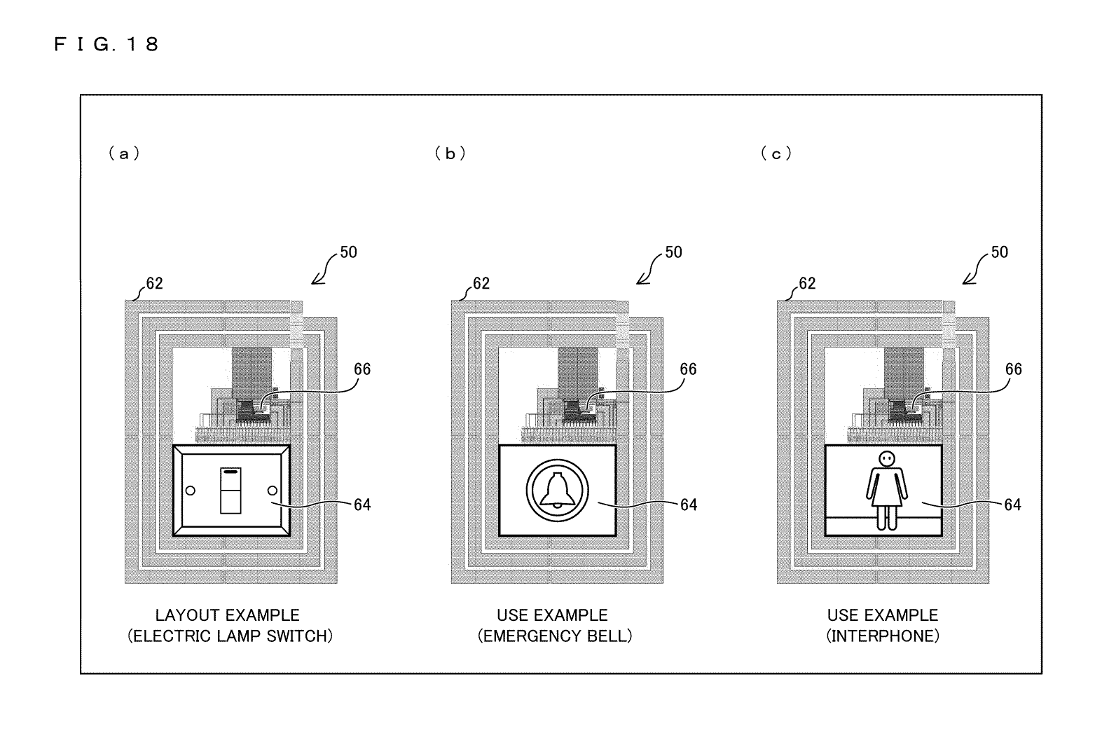

The following description deals with the flotage 50, with reference to (a) and (b) of FIG. 16, FIG. 17, and (a) and (b) of FIG. 18.

In the embodiment, (a) and (b) of FIG. 16 are views schematically illustrating configurations of an operation system 10 of an embodiment of the present invention. Moreover, FIG. 17 and (a) to (b) of FIG. 18 are views schematically illustrating a flotage 50 of an embodiment of the present invention.

As illustrated in (a) of FIG. 16, a system that transmits image display information among the operation systems 10 of the present embodiment has the peer 20 and the flotage 50 (image display system) perform transmission and reception in a wireless manner, caused by a change in magnetic field coupled by use of coils (coil A 10q, coil B 10r).

Furthermore, the peer 20 is configured as a host system 10a including a power and data source 101 and a transmitter system 10m. The host system 10a is provided separately from the flotage 50 later described.

In the flotage of the image display system 50, as a full monolithic flotage 10b, a receiver system 10x, a power and data sink, a LCD module (liquid crystal display section), and the like are formed on a thin film that is capable of carrying out circuit mounting, which thin film typically is thin film silicon.

More specifically, the flotage image display system 50 (of the image display system) includes, as illustrated in FIG. 17, a receiver 50a and a display module 50b (display section) as its main constituents.

The receiver 50a includes a power rectifier 50d, and a voltage regulator 50e and clock recovery 50f each connected to the power rectifier 50d. Power (power) is supplied from the voltage regulator 50e to not just the receiver 50a but also to the display module 50b.

Moreover, the receiver 50a includes a data rectifier 50h. This data rectifier 50h is connected to a demodulator 50i, which demodulator 50i is connected to a pulse sharpener 50j, which pulse sharpener 50j is connected to a Manchester decoder and synchronization 50k.

The Manchester decoder and synchronization 50k is also connected to the clock recovery 50f. Via a serial-parallel converter 50g, data is supplied to a control logic 50p and a frame memory 50q, each of which are provided in the display module 50b.

Moreover, the display module 50b includes, together with a backlight driver 50r and a DC-DC (DC-DC converter) 50s, a display system 50v. The display system (liquid crystal display section serving as a display section) 50v includes a display 50x, a gate driver 50y, and a source driver 50z. In this configuration, not just an entire monolithically formed flotage is driven but also a backlight LED (not illustrated) disposed on a rear surface of the flotage is driven simultaneously. This allows use of a transmissive liquid crystal display with the flotage.

Further, the display section of the flotage 50 can display various functional screens for the user.

Illustrated in (b) of FIG. 16 is a system for transmitting input operation information, among the operation systems 10 of the present embodiment. The part in which the peer 20 and the flotage 50 perform transmission, reception, and the like in a wireless manner caused by a change in magnetic field coupled by use of the coils (coil A 10q, coil B 10r) is identical to that of (a) of FIG. 16; whereas the part is different in a point that the transmission direction is in an opposite direction.

The operation transmission system 10b of the flotage 50 includes a touch panel module 10s, a data processor 10t, and a transmitter system 10u, which are formed fully monolithic on a substrate identical to the block constructing the flotage illustrated in (a) of FIG. 16. Further, the peer 20 is constructed as a component system (host system 10a) including a receiver system 10v and an apparatus operation processor 10w. Operations obtained from the touch panel are appropriately carried out by the apparatus operation processor.

The foregoing screen is described with reference to (a) and (b) of FIG. 18.

First, (a) of FIG. 18 illustrates a case where the flotage 50 is used as an electric lamp switch.

In this case, the flotage 50 has its display system 64 display an image of a switch. Hence, a user of the flotage 50 can operate the flotage 50 with a similar sense as that operating an actual switch.

Although the display section constituting the display system 64 is not particularly limited, an active matrix type liquid crystal display section is suitably used in terms of being capable of displaying a clear image and being easily switched over in display. In accordance with the operation, by switching the displayed image to an image in which the switch is fallen on an opposite side or by displaying a scene of the switch falling to the opposite side by animation, it is possible to provide the operator with a better operating sense. Moreover, vibration may be caused to add the sense of touch, simultaneously with the operation. Means for causing the vibration can be enabled by providing the excitation source as disclosed in Patent Literature 4.

Moreover, the display section has a device such as a touch panel or the like, which allows detection of an operation carried out by the user.

Next described is (b) of FIG. 18, in which the flotage 50 is used as an emergency bell.

In this case, the display system 64 of the flotage 50 displays an image of a bell.

Moreover, (c) of FIG. 18 illustrates a case where the flotage 50 is used as an interphone.

In this case, the display system 64 of the flotage 50 displays a state of a visitor. It is also possible to simultaneously have an audio input-output function; this also is enabled by having the flotage include the means disclosed in Patent Literature 4.

A possible configuration allowing the display of the visitor is for example a configuration in which the peer 20 is connected to the home server or the like, and the home server is made capable of receiving a video image from a front door camera or the like.

(Scene Using Operation System)

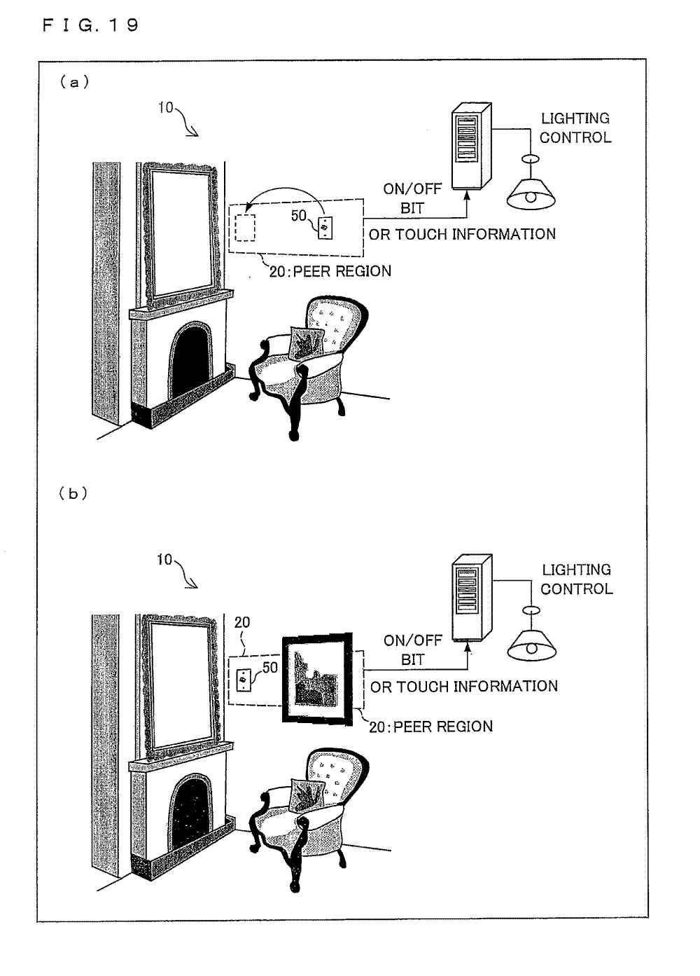

Next described is a scene using the operation system 10 of the present embodiment, with reference to (a) and (b) of FIG. 19. In the embodiment, (a) and (b) of FIG. 19 illustrates how the operation system 10 of the present embodiment is used in a western-style room.

As illustrated in (a) of FIG. 19, the peer 20 connected to a lighting control of a lighting is disposed on a wall.

In a region of the peer 20, the lighting is operated from the flotage 50 via the peer 20. Namely, the flotage 50 functions as a switch of the lighting.

In a case where for example a frame or the like is to be hung on the part on which the switch is initially disposed due to remodeling of the room, operation of the switch in the case the switch is fixed on the wall is made impossible since the switch hides behind the frame.

In comparison, the operation system of the present embodiment allows operation of the lighting from the flotage 50 from any position within the region of the peer 20.

Hence, as illustrated in (b) of FIG. 19, even if a frame is hung on any position, it is possible to operate the lighting as initially by moving the flotage 50. This allows providing a flexible operation system that can appropriately adapt with simple remodeling such as hanging a frame, and in a case of a major room remodeling such as reallocation of furniture, this configuration provides even further suitable flexibility.

The foregoing description mainly deals with a configuration in which the peer 20 is disposed on a wall surface. In the embodiment, the disposed position of the peer 20 is not limited to being disposed on the wall surface; the peer 20 may also be disposed on, for example, a floor surface.

### Another Embodiment

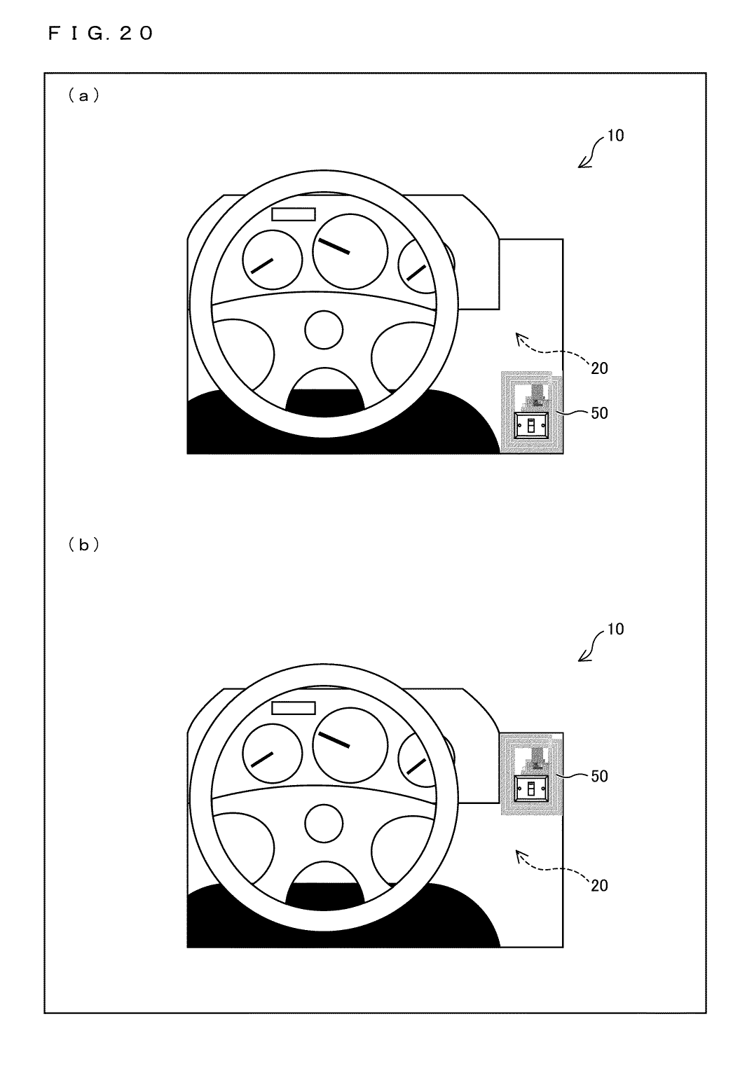

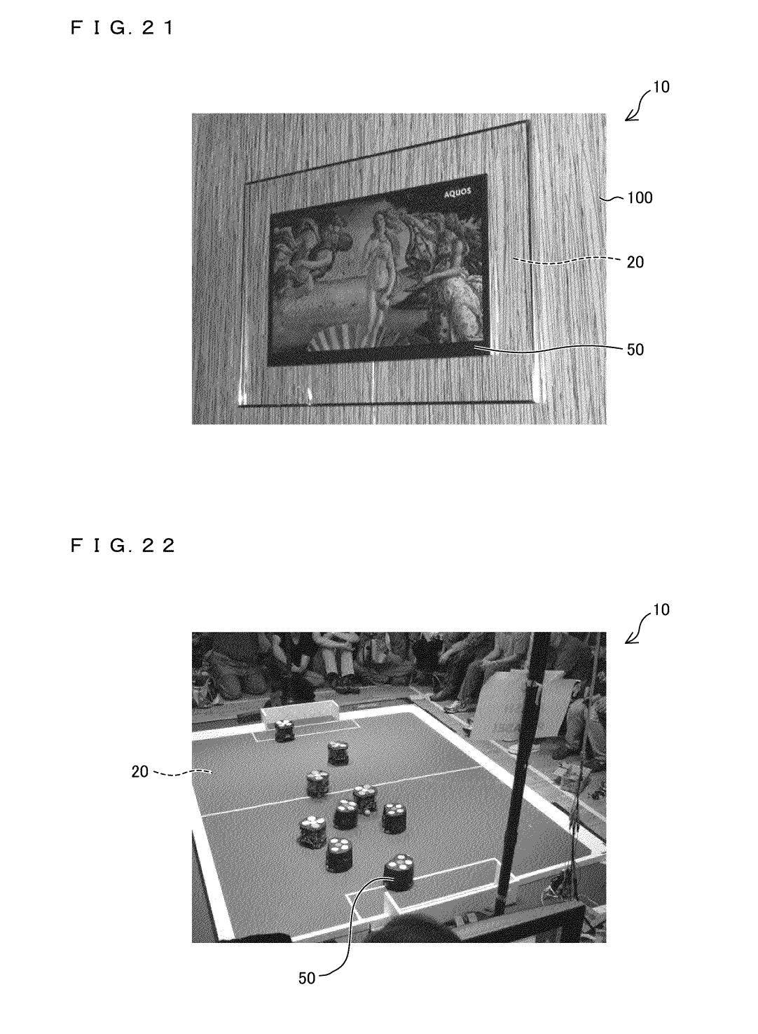

Another embodiment of the present invention is described below with reference to (a) and (b) of FIG. 20, and FIGS. 21 and 22.

In the embodiment, (a) and (b) of FIG. 20 illustrates how the operation system 10 is used inside a car. FIG. 21 illustrates how the operation system 10 is used as a framed display section on the wall 100. Moreover, FIG. 22 illustrates how the operation system is used for a game played on the floor.

The configurations other than what is described in the present embodiment are similar to those of Embodiment 1. Moreover, for easy description, identical reference signs are provided for members having identical functions as the members illustrated in the drawings of Embodiment 1, and explanations thereof have been omitted.

(Car)

In the embodiment illustrated in (a) and (b) of FIG. 20, the operation system 10 is applied to a car. The peer 20 is provided on, for example, a dashboard of the car. This peer 20 is connected to various devices mounted in a car (car devices such as a power window, audio devices and the like).

A driver or a fellow passenger of the car may reallocate the flotage 50 to any position on the dashboard in accordance with their height, length of their arm or the like, so as to allow easy operation of the various car devices.

(Framed Display Section)

In the embodiment illustrated in FIG. 21, the operation system 10 is applied as a frame of the wall 100. The peer 20 is disposed on the wall 100, and a frame serving as the flotage 50 is provided on the wall 100 on which the peer 20 is provided.

The flotage 50 includes an active matrix type liquid crystal display section; a picture, photograph, video or the like is displayed on the liquid crystal display section.

According to the configuration, power is supplied from the peer 20 (wall) to the flotage 50 (frame), and also image signals are transmitted to the flotage 50 from the peer 20.

Consequently, there is no need to separately connect a power source device to the flotage 50. This allows easily changing the position on the wall on which the flotage 50 is hung. Moreover, by changing the image signal, it is possible to easily switch over an arbitrary image that is displayed on the frame.

(Game)

In the embodiment illustrated in FIG. 22, the operation system 10 is provided inside a floor surface. An example of applying the peer disposed on the floor is an application of the operation system 10 to a game. In this example, the peer 20 is disposed in the floor, and pieces used in the game serve as the flotage 50.

According to the configuration, correspondence of information related to positioning of the pieces and like information is possible between the pieces serving as the flotage 50 and the floor serving as the peer 20.

Since this configuration allows collective acknowledgement and control of a state of progress of the game by use of a server or the like that is connected to the floor, it is possible to dynamically enjoy, with many great people, a game together with a player of a remote place, by use of an entire floor surface, store its history, and the like.

The pieces serve as the flotage; hence, the power is supplied from the floor.

Moreover, another possible configuration is to dispose the peer 20 on the floor, and a game mat be provided as the flotage 50. In this case, the display section included in the flotage 50 displays a picture or the like of the game mat.

According to such a configuration, it is possible to display any pictured game mat in accordance with the type of game played.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

Due to its highly free layout and its low security risks, the present invention is suitably used for use in, for example, operating many apparatuses connected to a home server or the like. Moreover, the present invention is suitably applicable in disposing electrical apparatuses, which makes interior remodeling of a house remarkably easier, even in a case where no collective control is carried out via a home server.

### REFERENCE SIGNS LIST

10 operation system
20 peer (operation host section)
50 flotage (operation terminal)

1. An operation system comprising:
an operated apparatus;
an operation host section connected to the operated apparatus; and
an operation terminal configured to operate the operated apparatus via the operation host section, being supplied with power from the operation host section in a non-contact manner,
the operated apparatus being operated by use of an operation signal, the operation signal being transmitted between the operation terminal and the operation host section in a non-contact manner, and
the operation terminal and the operation host section being disposed so that the supplying of the power and the transmission of the operation signal are carried out within a range in which a distance between the operation apparatus and the operation host section is not more than 5 cm.

2. The operation system according to claim 1, wherein the operation apparatus and the operation host section are disposed so that the supplying of the power and the transmission of the operation signal are carried out within a range in which the distance between the operation terminal and the operation host section is not more than 2 cm.

3. The operation system according to claim 1, wherein, at a time when the power is supplied from the operation host section to the operation terminal, the supplying is carried out under an energy transfer rate of at least 10%.

4. The operation system according to claim 2, wherein, at a time when the power is supplied from the operation host section to the operation terminal, the supplying is carried out under an energy transfer rate of at least 60%.

5. The operation system according to claim 1, wherein:
the operated apparatus is a domestic apparatus, and
the operation host section is shaped as a substrate and is disposed on a wall of a room inside a house.

6. The operation system according to claim 5, wherein the operation host section shaped as a substrate is disposed on a surface of the wall of the room inside the house.

7. The operation system according to claim 5, wherein the operation host section shaped as a substrate is disposed inside the wall of the room inside the house.

8. The operation system according to claim 5, wherein the operation host section shaped as a substrate is disposed inside a depression formed on the wall of the room inside the house.

9. The operation system according to claim 8, wherein the wall is made of material that allows easy forming of the depression in which the operation host section is disposed.

10. The operation system according to claim 5, wherein the operation host section shaped as a substrate is disposed on substantially a whole surface of the wall of the room.

11. The operation system according to claim 5, wherein the operation host section shaped as a substrate is disposed on the wall of the room just near a position of the room at which a user of the room operates the operated apparatus in accordance with a main use of the room.

12. The operation system according to claim 5, wherein, on a wall of a staircase inside the house, the operation host section shaped as a substrate is disposed so that the operation host section runs along an inclination of the staircase.

13. The operation system according to claim 5, wherein a plurality of pieces of the operation host section shaped as a substrate are disposed on a single surface of the wall.

14. The operation system according to claim 13, wherein the plurality of pieces of the operation host section shaped as a substrate are rectangular-shaped, and are disposed on the single surface of the wall so that the plurality of pieces of the operation host section are disposed parallel to each other.

15. The operation system according to claim 13, wherein the plurality of pieces of the operation host section shaped as a substrate are substantially square-shaped, and are disposed on the single surface of the wall so that the plurality of pieces of the operation host section form a matrix.

16. The operation system according to claim 1, wherein:
the operated apparatus is a domestic apparatus, and
the operation host section is shaped as a substrate and is disposed on a floor of a room in a house.

17. The operation system according to claim 16, wherein the operation host section shaped as a substrate is disposed on a surface of the floor of the room of the house.

18. The operation system according to claim 16, wherein the operation host section shaped as a substrate is disposed inside the floor of the room of the house.

19. The operation system according to claim 16, wherein a plurality of pieces of the operation host section shaped as a substrate are disposed on a single surface of the floor.

20. The operation system according to claim 19, wherein the plurality of pieces of the operation host section shaped as a substrate are substantially square-shaped, and are disposed on the single surface of the floor so that the plurality of pieces of the operation host section form a matrix.

21. The operation system according to claim 1, wherein the operation terminal has no independent power source.

22. The operation system according to claim 1, wherein the operation terminal includes a simplified power storage capable of continuously operating for a short term outside a power supplied range.

23. The operation system according to claim 1, wherein the operation terminal includes a fixing device configured to fix the operation terminal near the operation host section.

24. The operation system according to claim 23, wherein the fixing device is provided so that repetitive fixing and detaching is possible.

25. The operation system according to claim 23, wherein the fixing device is adhesive material.

26. The operation system according to claim 1, wherein the operation terminal includes means which allows confirmation of an operation target by sight or touch.

27. The operation system according to claim 26, wherein the means includes an excitation source configured to vibrate together with the operation of the operation terminal, so that the operation object can be confirmed by touch.

28. The operation system according to claim 1, wherein the operation terminal includes an electrically operating display section.

29. The operation system according to claim 28, wherein the display section is a dot matrix type display section.

30. The operation system according to claim 1, wherein the operation signal transmitted between the operation terminal and the operation host section is transmitted via electromagnetic waves.

31. The operation system according to claim 1, wherein the operation signal transmitted between the operation terminal and the operation host section is transmitted via light.

32. The operation system according to claim 31, wherein the light is visible light and the operation system is designed so that the light is usable as decoration.

33. The operation system according to claim 1, wherein:
the operation terminal includes a load impedance modulation section configured to change a load,
the operation host section includes a load modulation detection section configured to detect a change in electric current that flows in a constant-voltage power source, the change being caused by a change in the load, and
the operation signal is transmitted from the operation terminal to the operation host section upon detecting the change in electric current.

34. The operation system according to claim 1, wherein:
the operated apparatus is a domestic apparatus,
a plurality of the domestic apparatus are provided inside a house, and
the operation host section is connected to a home server connected to the plurality of the domestic apparatuses.

35. The operation system according to claim 1, wherein:
the operated apparatus is a car device mounted on a car,
the operation host section shaped as a substrate, and
the operation host section shaped as a substrate is disposed on an interior decoration of the car.
